(19) United States
(12) Patent Application Publication
(10) Pub. No.: US 2005/0000154 A1
(43) Pub. Date: Jan. 6, 2005

(54) Apparatus and methods for enhanced plant and lawn growth using alkane injection

(75) Inventors: Felix Anthony Perriello, Norwood, MA (US); George A. DiCesare, Norwood, MA (US)

Correspondence Address: Tara L. Pfaeffle;Pietragallo, Bosick & Gordon, One Oxford Centre, 38th Floor, 301 Grant Street, Pittsburgh, PA, 15219, US

(73) Assignee: Global BioSciences, Inc., North Attleborough, MA (US)

(21) Appl. No.: 10/852,752

(22) Filed: May 24, 2004

Related U.S. Application Data
(63) Continuation-in-part of application No. 10/282,891, filed on Oct. 29, 2002.
(60) Provisional application No. 60/473,181, filed on May 23, 2003.
(60) Provisional application No. 60/334,981, filed on Oct. 31, 2001.

(51) Int. Cl. A01N 43/76

(52) U.S. Cl. 47/58.1 SC

(57) ABSTRACT

Apparatus and methods are provided for introducing an alkane to a plant in order to stimulate the plant's growth. Any type of plant may be treated, including potted plants, shrubs, trees, lawns, agricultural crops and the like. In a preferred embodiment, the alkane comprises butane, but other compounds can be used, including methane, ethane and propane. The alkane may be combined with water or another liquid carrier, or plant growth-enhancing additives such as nutrients, insecticides and alkane-utilizing bacteria. To induce aerobic conditions, oxygen-containing gas such as air may be introduced along with the alkane or separately from the alkane. The introduction of alkane may enhance plant growth by increasing the indigenous microbial populations in soil, e.g. bacteria, fungi, protists, and prokaryotes, which may provide benefits such as increased nutrient uptake, faster root development, and reduced heat, drought and cold stress, resulting in enhanced plant growth.

### CROSS-REFERENCE TO RELATED APPLICATIONS

This application claims the benefit of U.S. Provisional Patent Application Ser. No. 60/473,181, filed May 23, 2003, which is incorporated herein by reference.

This application is also a continuation-in-part of U.S. patent application Ser. No. 10/282,891, filed Oct. 29, 2002, which claims the benefit of U.S. Provisional Patent Application Ser. No. 60/334,981, filed Oct. 31, 2001, which are incorporated herein by reference.

### FIELD OF THE INVENTION

The present invention relates to systems for introducing alkanes, such as butane, to a plant in order to stimulate the plant's growth.

### BACKGROUND INFORMATION

Soil systems contain a variety of microorganisms including bacteria, fungi and algae. Bacterial populations in soil survive and flourish depending on the availability of nutrients and carbon sources. Aerated soils including topsoil typically have the highest population of bacteria. A level of population for each type of bacteria in soil is defined based on the competition among soil bacteria. Competition may be shifted toward a specific type of bacteria due to changes in the availability of growth requirements as well as changes resulting in the alteration of physical or chemical conditions within the subsurface environment. The addition or natural presence of a carbon source becomes a major element affecting the bacterial diversity in an ecosystem. Fungi live in symbiotic relationships with plants among their roots, feeding on organic materials and assisting plants in water and mineral uptake. A number of genera of algae live both on the soil surface and within the soil, where they produce oxygen used by aerobes and serve as a food source for other microorganisms.

Commercial growers have access to inoculant products that add specific beneficial fungi and bacteria to a soil mix, growing bed or crop. It is reported by some that these microorganisms help prevent disease, increase plants' tolerance to stress and increase their vigor. Some farmers and crop growers have claimed that these products even increase plants' cold tolerance. These products are available as a powder to mix with water and add to soils, or as granular material that is mixed with water and added to soil. Some of these products are mixed with nutrients that also increase the number of existing microorganisms.

In general, bacteria-based products are lower in cost than fungal-based products or enhancers. Both the bacterial products and fungal products are designed to increase nutrient uptake, promote faster root development, and reduce heat, drought and cold stress. These products also stimulate other beneficial soil microorganisms to thrive. Thus, these commercial products increase overall crop health, even those crops grown in soil-less media or in soil that has become exhausted and overworked. However, soil based amendments applied through inoculation methods may not be effective or reliable.

### SUMMARY OF THE INVENTION

In accordance with the present invention, apparatus and methods are provided for introducing an alkane, such as butane, to a plant in order to stimulate the plant's growth. The apparatus may include pressurized canisters with applicators designed to inject the alkane into the soil surrounding a plant, and skid-mounted spray systems designed to distribute the alkane to a lawn or field. Any type of plant may be treated in accordance with the present invention, including potted plants (such as flowers, decorative plants and herbs), hydroponic plants, shrubs, trees, lawns, agricultural crops and the like. In one embodiment of the present invention, the alkane comprises butane, but other compounds can be used such as methane, ethane, propane or any higher order alkane. The alkane may be combined with water, which serves as a carrier for the alkane, and other plant growth-enhancing additives, e.g., nutrients including nitrogen, ammonia, orthophosphate and fertilizer, insecticides and/or alkane-utilizing bacteria. To induce aerobic conditions, oxygen-containing gas such as air may also be introduced. These additives may be combined with the alkane before it is administered to a plant, or introduced to the plant separately from the alkane.

The introduction of an alkane may enhance plant growth by increasing the indigenous microbial populations in soil within the region of plant growth known as the rhizosphere. This increase in microbial populations may provide benefits such as increased nutrient uptake, faster root development, and reduced heat, drought and cold stress, resulting in enhanced plant growth. Microbial populations that may be affected include bacteria, fungi, protists, prokaryotes or the like.

One aspect of the present invention is to provide an apparatus for enhancing plant growth comprising a source of alkane and an applicator in flow communication with the alkane source for applying the alkane to a plant.

Another aspect of the present invention is to provide an apparatus for enhancing plant growth, the apparatus comprising a plant container and an alkane injector in flow communication with the plant container.

A further aspect of the present invention is to provide an apparatus for enhancing plant growth, the apparatus comprising an alkane source; a tank in flow communication with the alkane source; and a sprayer for applying the alkane source to a plant, wherein the sprayer is in flow communication with the tank.

Another aspect of the present invention is to provide a method for enhancing growth of a plant, the method comprising applying an alkane to the plant using an applicator that is in flow communication with a source of the alkane.

These and other aspects of the present invention will be more apparent from the following description.

### BRIEF DESCRIPTION OF THE DRAWINGS

FIG. 1 is a schematic representation of an apparatus for enhancing plant growth in accordance with an embodiment of the present invention.

FIG. 2 is a schematic representation of an apparatus for enhancing plant growth that includes a venturi system in accordance with an embodiment of the present invention.

FIGS. 3-5 are schematic representations of a method for operating an apparatus for enhancing plant growth in accordance with an embodiment of the present invention.

FIG. 6 is a schematic representation of an apparatus for enhancing plant growth including an aeration bulb in accordance with an embodiment of the present invention.

FIG. 7 is a schematic representation of an apparatus for enhancing plant growth using a skid-mounted assembly and sprayer in accordance with an embodiment of the present invention.

FIG. 8 is a schematic representation of a plant growth vessel including a perforated butane injection tube in accordance with an embodiment of the present invention.

FIG. 9 is a top view of the vessel of FIG. 8.

FIG. 10 is a schematic representation of enhanced plant growth in a vessel including a butane injector in comparison with a vessel without a butane injector.

FIG. 11 is a photograph of seedlings grown with butane enhancement in comparison with a control sample in which seedlings were grown without butane enhancement.

FIG. 12 includes comparative photographs showing plant root growth in a butane enhanced vessel versus root growth in a control vessel.

FIG. 13 is a photograph comparing root lengths for plants grown with butane enhancement versus root lengths for plants grown without such enhancement.

FIG. 14 is a photograph comparing seedlings growth in a vessel with butane enhancement versus seedlings grown in a vessel without butane enhancement.

FIG. 15 is a photograph comparing butane enhanced root growth versus non-butane enhanced root growth.

FIG. 16 is a photograph comparing butane enhanced root growth versus non-butane enhanced root growth.

FIG. 17 is a photograph showing root growth in a control sample without butane enhancement.

FIG. 18 is a photograph showing butane enhanced root growth at the bottom of a vessel.

FIG. 19 is a photograph showing butane enhanced root growth.

FIG. 20 is a schematic diagram depicting experimental vessels for enhanced plant growth using butane biostimulation.

FIG. 21 is a photograph showing experimental vessels for enhanced plant growth using butane biostimulation and Gladioli bulbs.

FIG. 22 is a photograph of a control Gladioli bulb and butane enhanced Gladioli bulbs.

FIG. 23 is a photograph showing experimental vessels for butane enhanced sunflower plant growth in sand.

FIG. 24 is a photograph of a control seed and a butane enhanced seed for butane enhanced sunflower plant growth in sand.

FIG. 25 is a photograph of seed germination for butane enhanced sunflower plant growth in sand.

FIG. 26 is a photograph of the roots of a control plant and a butane enhanced plant for butane enhanced sunflower plant growth in sand.

FIG. 27 is a photograph showing experimental vessels for butane enhanced corn growth in sand using butanated water.

FIG. 28 is a schematic diagram showing the devices used to add butanated water for butane enhanced corn growth in sand using butanated water.

FIG. 29 is a photograph showing control and butanated water seed growth for butane enhanced corn growth in sand using butanated water.

FIG. 30 is a photograph showing control and butanated water root growth for butane enhanced corn growth in sand using butanated water.

FIG. 31 is a photograph showing control, butanated water, and butane gas injection root growth for butane enhanced corn growth in sand using butanated water.

### DETAILED DESCRIPTION OF THE INVENTION

In accordance with the present invention, apparatus and methods are provided for introducing an alkane, such as butane, to a plant in order to stimulate the plant's growth. The apparatus may include pressurized canisters with applicators designed to inject the alkane into the soil surrounding a plant, and skid-mounted spray systems designed to distribute the alkane to a lawn or field. Any type of plant may be treated in accordance with the present invention, including potted plants (such as flowers, decorative plants and herbs), hydroponic plants, shrubs, trees, lawns, agricultural crops and the like. As used herein, the term “plant” refers to all types of plants capable of experiencing enhanced growth through the introduction of alkane.

In one embodiment of the present invention, the alkane comprises butane, but other alkane compounds can be used such as methane, ethane or propane, or any combination thereof. As used herein, the term “alkane source” includes any solid, liquid or gas in which an alkane is present in sufficient amounts to stimulate plant growth. The alkane may be combined with water or plant growth-enhancing additives such as nutrients (e.g., nitrogen, ammonia, orthosphosphate and fertilizer), insecticides and/or alkane-utilizing bacteria. These additives can be mixed with the alkane or applied to a plant separately from the alkane. To induce aerobic conditions, oxygen-containing gas such as air may also be introduced either along with the alkane or separately from the alkane. The introduction of oxygen-containing gas may be accomplished by any suitable means such as injection tubes for introducing the gas alone or in a carrier fluid, or by exposing the plant to the atmosphere.

The alkane and various additives can be delivered to locations adjacent to plants using one or more applicators, with an end or other portion of the applicator extending into the desired location. The delivery of alkane can be accomplished by injecting on or into the soil in which a plant is growing and/or germinating, or by applying directly to a plant (i.e., “topically”) or to the water utilized by a plant. The alkane source can be connected to the applicator through one or more pipes or tubes.

As used herein, any reference to “applying” the alkane includes all of the above-mentioned methods of delivery. The alkane may be delivered intermittently or periodically, e.g., on a daily or weekly basis.

The alkane can be introduced with a pusher gas, such as helium. One or more valves can be used between the alkane source, a pusher gas source and the applicator to control the flow of the alkane and the pusher gas. A controller can be provided to control the valve, and the controller can include a timer that controls the timing of operation of the valve. The alkane can be supplied in gaseous or liquid form. Various forms of applicators or injectors can be used, including applicators having an inlet (i.e., proximal end) for receiving the alkane and an outlet (i.e., distal end) for dispersing the alkane to a plant. The distal end can include a nozzle or a sprayer with a plurality of openings.

The introduction of alkane may enhance plant growth by increasing the indigenous microbial populations in soil within the region of plant growth known as the rhizosphere. This increase in microbial populations may provide benefits such as increased nutrient uptake, faster root development, and reduced heat, drought and cold stress, resulting in enhanced plant growth. Microbial populations that may be affected include bacteria, fungi, protists, prokaryotes and the like.

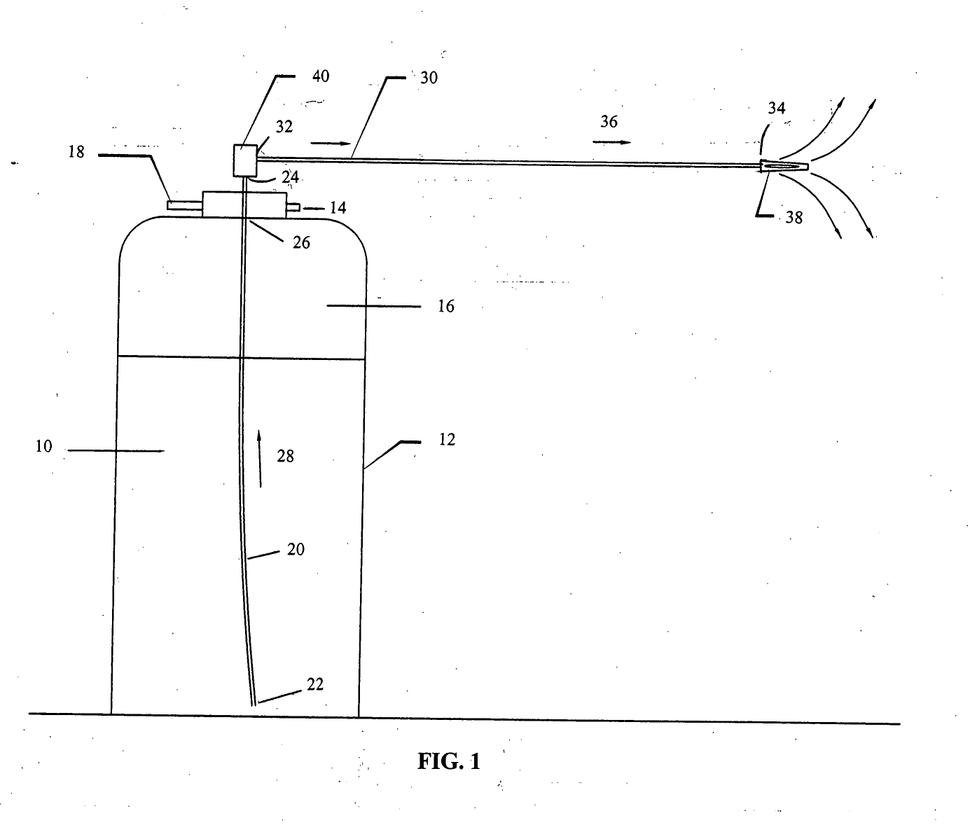

FIG. 1 is a schematic representation of an apparatus for enhancing plant growth in accordance with an embodiment of the present invention. As shown in FIG. 1, an alkane source 10 such as butane in either gaseous or liquid form may be contained within a canister 12 or other suitable container. The canister 12 or container may be made from plastic, metal or any other suitable material, and it may be refillable or replaceable. The canister 12 or container may include a fill port 14 for refilling its contents. The canister 12 may also contain a pressurization gas 16 such as air, nitrogen, oxygen or the like. The pressurization gas 16 may be introduced through a pressurization port 18 on the canister 12.

In a preferred embodiment, the canister 12 contains a head space of air 16 that is pressurized with nitrogen and/or oxygen. If oxygen is used, the head space must be fully inerted to avoid flammability. The remainder of the canister 12 may contain butane or a butane and water mixture 10. The total contents of the canister 12 may have a pressure ranging from above atmospheric pressure to 200 psi. In one embodiment, the canister 12 may contain a butane and nitrogen mixture, with the butane having an initial pressure ranging from about 15 psi to 20 psi, and the nitrogen further pressurizing the contents of the canister to a pressure ranging from about 115 psi to about 120 psi.

The alkane source 10 is connected to an applicator which comprises an uptake tube 20 and an application tube 30. The uptake tube 20 may be positioned in the canister 12 and at least partially submerged within the alkane source 10. The uptake tube 20 has an inlet 22 positioned in the alkane source 10 and an outlet 24 that is external to the canister 12. The canister 12 may have an opening 26 that is structured and arranged to receive the uptake tube 20. The purpose of the uptake tube 20 is to draw the alkane source 28 from the canister for application to a plant. The apparatus also includes an application tube 30 which has an inlet 32 and an outlet 34. The purpose of the application tube 30 is to distribute the alkane source 36 onto a plant once the alkane source 10 is removed from the canister 12. The inlet 32 of the application tube 30 is in flow communication with the outlet 24 of the uptake tube 20, and the outlet 34 of the application tube 30 is structured and arranged for application of the alkane source 10, e.g., by inserting the outlet 34 of the application tube 30 into soil at any given depth, or by positioning the outlet 34 near the plant's leaves or the surface of its soil. The uptake tube 20 and the application tube 30 may be made from any suitable material, e.g., plastic, rubber, metal or materials that conform in shape when bent.

The outlet 34 of the application tube 30 may be fitted with a flow tip 38 for distribution of the alkane source 10. In particular embodiments, the flow tip 38 comprises a nozzle with a tapered end or a sprayer with holes. A valve 40 is structured and arranged to regulate flow between the uptake tube 20 and the application tube 30. In a particular embodiment, the alkane source is drawn into the uptake tube 28 and through the application tube 36 when the valve 40 is depressed.

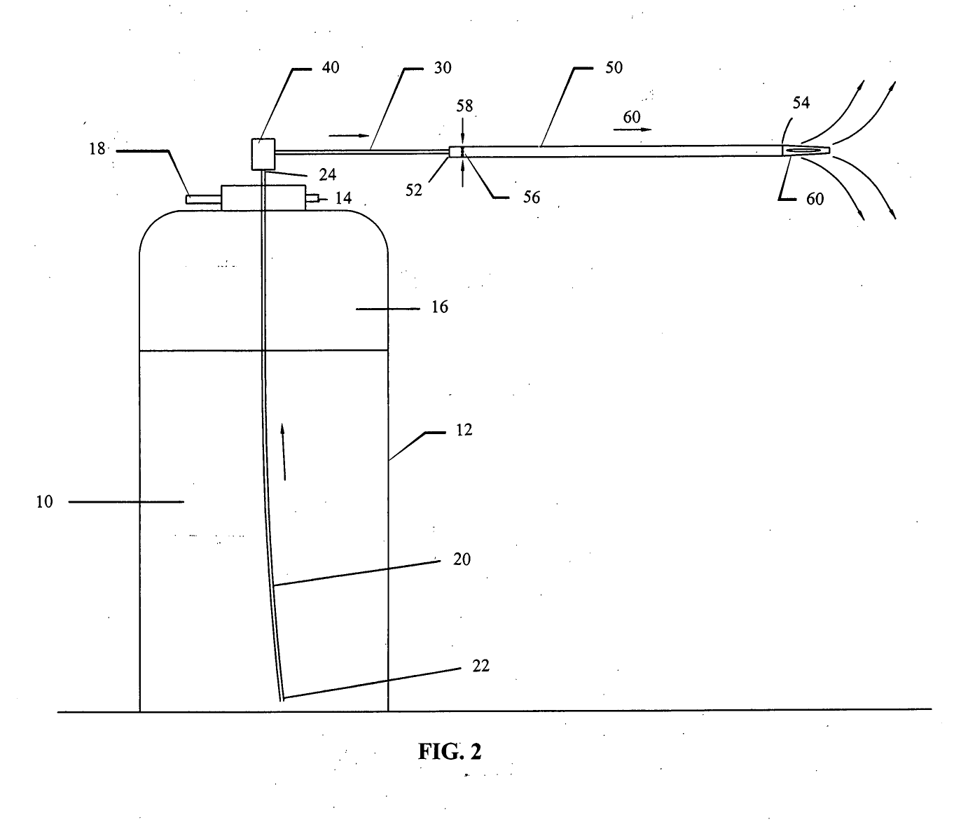

FIG. 2 presents another embodiment of the present invention. In this embodiment, the application tube 30 is fitted with a venturi 50 which is structured and arranged to at least partially cover the application tube 30. The primary purpose of the venturi 50 is to entrain air in the alkane when the alkane is applied to the plant, although the venturi 50 may also entrain water, plant growth-enhancing additives, or the like. The venturi 50 has an inlet 52 and an outlet 54 with at least one air inlet hole 56 located near the inlet 52. When the valve 40 is depressed, air is drawn into the air inlet hole(s) 58 and through the venturi 60. The air creates a venturi effect which assists in pushing the alkane source 10 through the application tube 30 for subsequent distribution to a plant. The outlet 54 of the venturi 50 may be fitted with a flow tip 60, e.g., a nozzle with a tapered end or a sprayer with holes.

Although the apparatus shown in FIGS. 1 and 2 are primarily used for potted plants, other non-potted plants, such as shrubs, trees and lawns, may be treated with a similar system, e.g., a scaled-up version of the apparatus shown in FIGS. 1 and 2. Furthermore, the apparatus shown in FIGS. 1 and 2 may be modified for various applications. For example, the alkane source 10 may be mixed with another fluid such as water. In this case, the water may serve as a carrier for the alkane while also serving to water the plant. The alkane/water mixture may be provided in the canister 12, or the water may be provided separately from the alkane. For example, water from a container or hose may be mixed with the alkane source 10 just prior to introduction to a plant. Alternatively, the water and alkane source 10 may be delivered separately to the soil, e.g., sequentially through the same injector, or through separate injection or spray lines. In addition, plant growth-enhancing additives such as nutrients (e.g., nitrogen, ammonia, orthophosphate and fertilizer), insecticides and alkane-utilizing bacteria may be combined with the water or alkane/water mixture, which serves as a carrier for these additives.

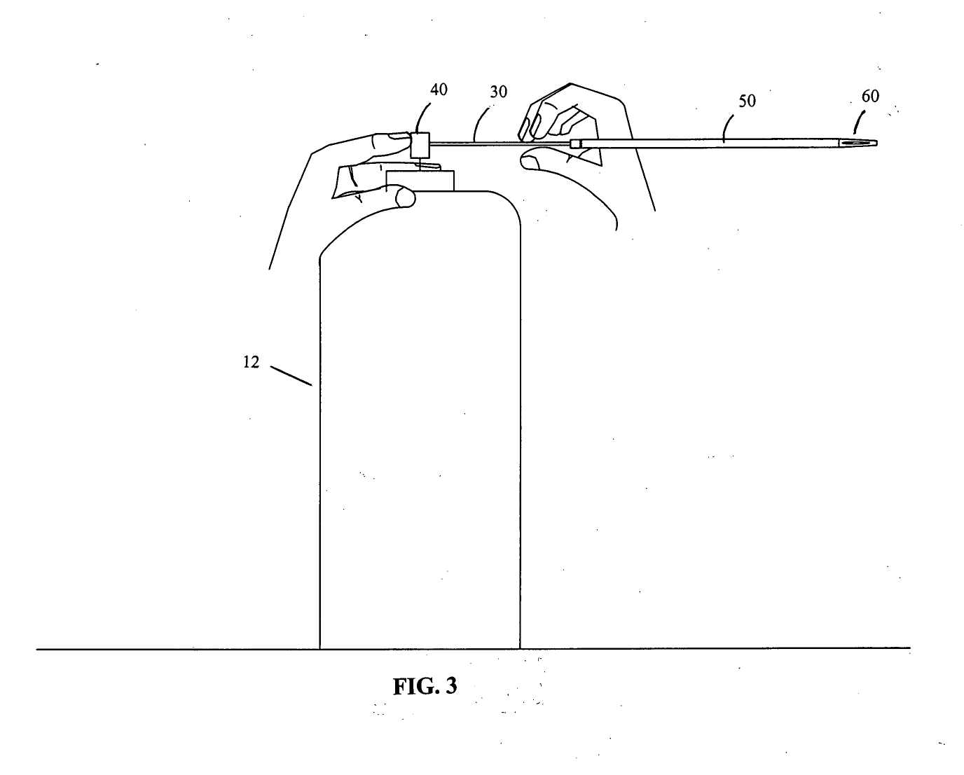

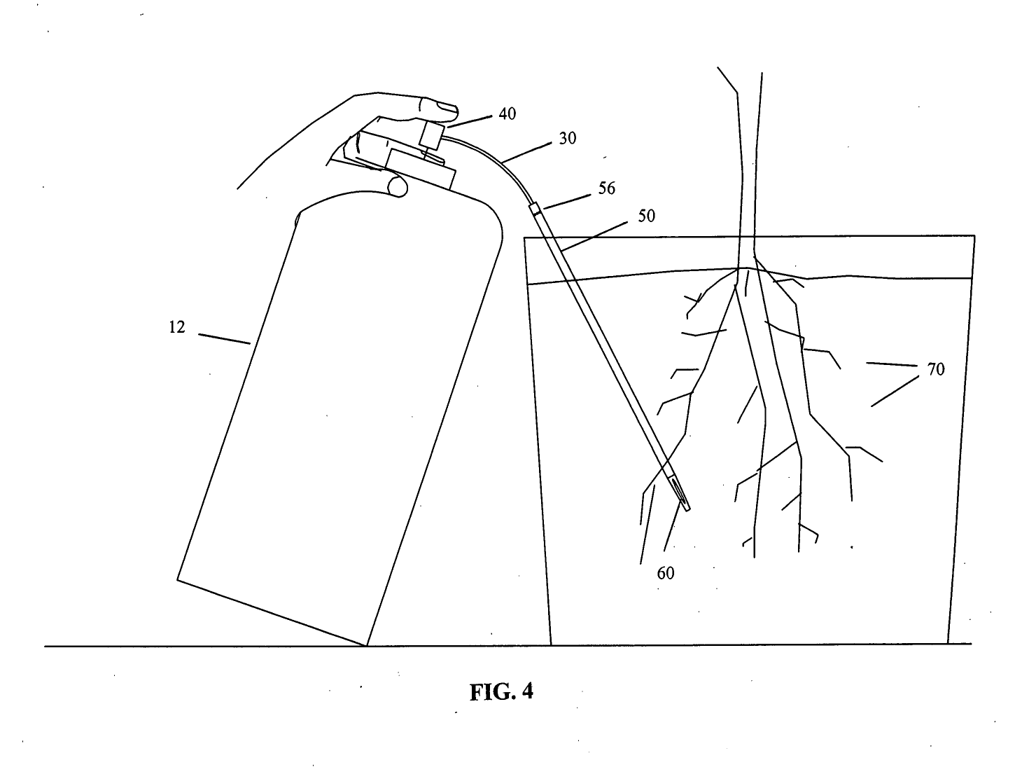

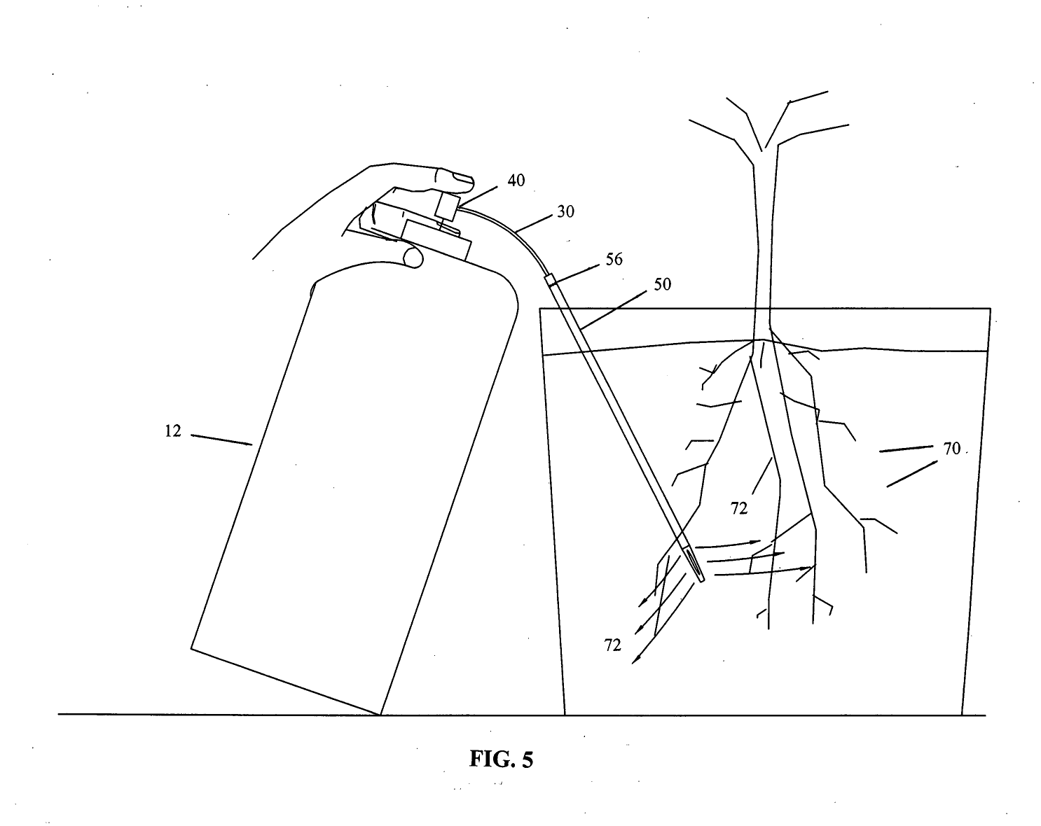

FIGS. 3-5 depict a method of operation for the apparatus shown in FIGS. 1 and 2. As shown in FIG. 3, an application tube 30 may be attached to the valve 40 by pushing the tube 30 into the valve 40. As shown in FIG. 4, the application tube 30 is then inserted into the soil surrounding a plant within the plant root zone (rhizosphere) 70. If a venturi 50 is attached to the application tube 30, a clear, unobstructed opening must be left around the air inlet holes 56. As shown in FIG. 5, when the valve 40 is depressed, the contents of the canister 12, including the alkane source 10, are sprayed 72 into the rhizosphere 70.

In another embodiment of the present invention, the alkane source and applicator are provided as integral components of a container that houses a plant and its soil, such as a pot. The alkane source and applicator are attached to the container, with one or more application tubes extending into various locations within the soil or plant root zone. When a valve on the alkane source is depressed, the alkane is distributed through the application tubes and onto the plant or into the soil. The alkane source may be removably attached to the container or pot so that it can be easily removed for storage, refilled, or replaced. The alkane source and application tubes may be hidden on the interior of the pot so that they are not visible on the pot's exterior surface. In a particular embodiment, the applicator comprises a perforated tube located in the interior of the container.

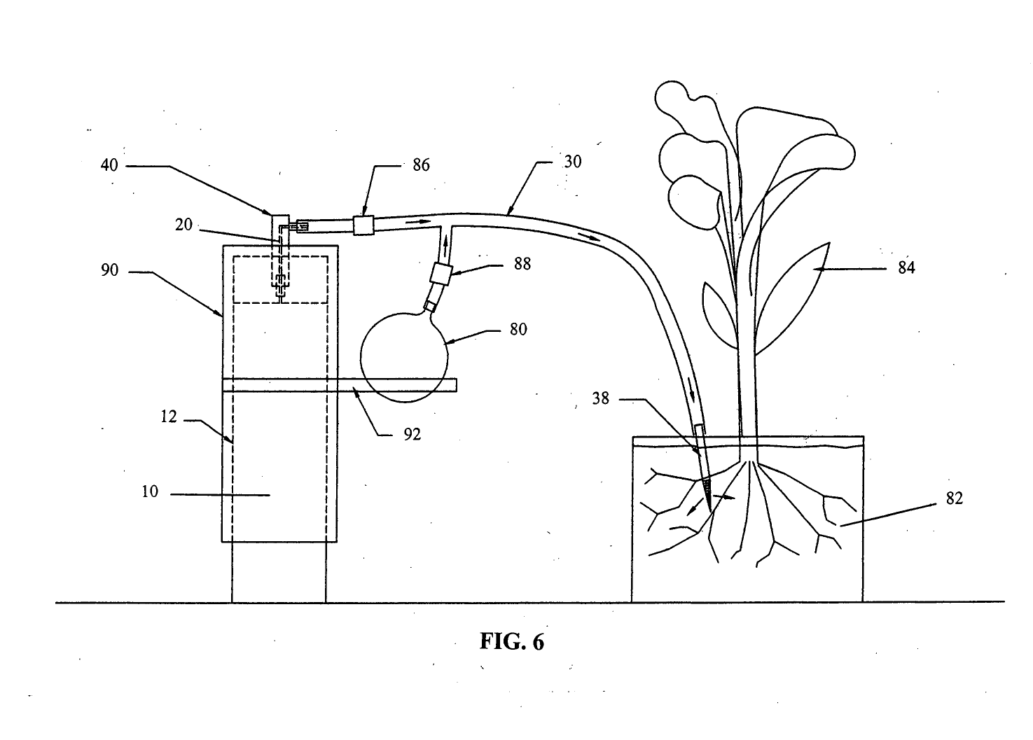

FIG. 6 presents an alternative embodiment of an apparatus for enhancing plant growth. This embodiment includes an aeration bulb 80 that is connected to an application tube 30. The application tube 30 is in flow communication with an uptake tube 20 that is positioned within a canister 12 and partially submerged in an alkane source 10. When a valve 40 is depressed, the alkane source 10 is drawn into the uptake tube 20 and through the application tube 30 and flow tip 38 for ultimate distribution to the root zone 82 of a plant 84. The application tube 30 may be closed off from the uptake tube 20 and valve 40 by a check valve 86. Before or at the same time that the valve 40 is depressed, the aeration bulb 80 may be hand-pumped to inject air into the application tube 30. This air mixes with the alkane that is released into the application tube 30, providing oxygen to the root zone 82 and the plant 84 and possibly assisting in pushing the alkane through the application tube 30. The aeration bulb 80 may be closed off from the application tube 30 by a check valve 88. The canister 12 may be fitted with a removable adapter body 90 that may include a holder 92 for the rubber aeration bulb 80 and a built in valve 40. The canister 12 may be removed from the adapter body 88 for refill or replacement.

The following method may be used to operate the apparatus depicted in FIG. 6:
1. Insert flow tip 38 into soil profile near plant 84 or flower root zone 82.
2. Remove rubber aeration bulb 80 from holder 92 and hand pump three times.
3. Depress valve 40 for three seconds.
4. Remove flow tip 38 and place in a different location.
5. Repeat steps 2 and 3 until plant 84 has had sufficient injections to cover all sides.
6. Remove flow tip 38. Remove application tube 30 from valve 40. Pump rubber aeration bulb 80 to evacuate lines.
7. Return rubber aeration bulb 80 to holder 92.

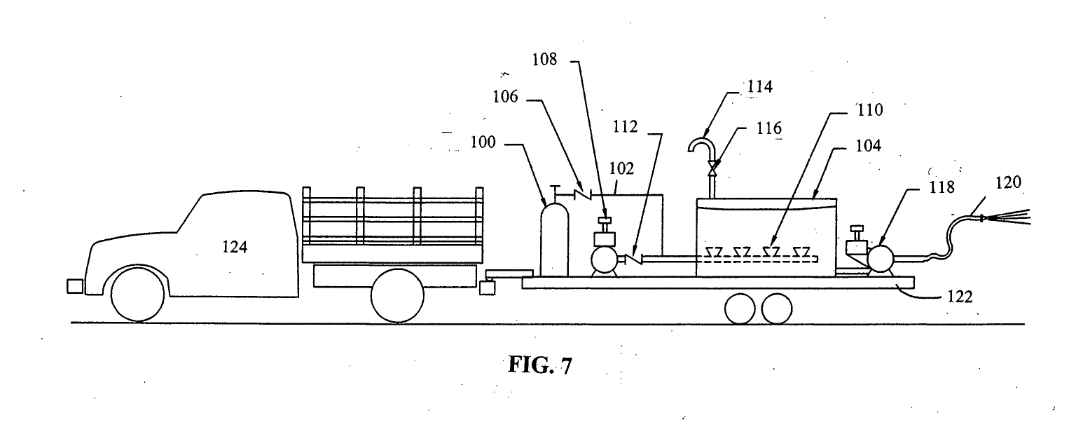

FIG. 7 is a partially schematic illustration of a skid-mounted assembly and sprayer in accordance with another embodiment of the present invention. Although the alkane spray system shown in FIG. 7 is primarily used for lawns, other applications are possible, such as trees, shrubs and agricultural crops. The skid-mounted assembly includes an alkane source 100, e.g., an n-butane cylinder, that is connected by pipeline 102 to a tank 104. The alkane source 100 is in flow communication with the tank 104, and a check valve 106 regulates flow between the two. The tank 104 may contain water or some other liquid that serves as a carrier for the alkane source 100 when the alkane is introduced into the tank 104 through the pipeline 102. The water in the tank 104 may also contain plant growth-enhancing additives such as nutrients (e.g., nitrogen, ammonia, orthophosphate and fertilizer), insecticides and alkane-utilizing bacteria.

In addition, the assembly may include an air pump 108 that introduces air into the tank water through a gas diffuser 110. The flow of air between the air pump 108 and the tank water may be controlled with a check valve 112. Furthermore, the tank 104 may include an air vent 114 with an air vent valve 116. Once the alkane and water are mixed within the tank 104, they are sent to a power sprayer 118 that may have an adjustable hose 120 for application on a lawn, crop field, tree, shrub or other plant. The entire assembly may be mounted on a skid 122 and transported using a truck 124, or mounted and transported using any other suitable equipment. In an alternative embodiment, plant growth-enhancing additives such as nutrients, insecticides and alkane-utilizing bacteria are applied to the lawn, crop field or plant separately from the water/alkane mixture.

A method of operation for the apparatus shown in FIG. 7 is as follows:
1. Open air vent valve 116 on tank 104.
2. Turn air pump 108 on to oxygenate water in tank 104. Run for period of time. Turn off air pump 108.
3. Close air vent valve 116.
4. Feed alkane from alkane source 110 into tank 104.
5. Use power sprayer 118 to irrigate lawn or crop field, or to water plant.

The system shown in FIG. 7 may be modified, e.g., by using a non-aerated alkane/water mixture. In this case, aeration may be achieved by combining the alkane/water spray treatment with conventional lawn aeration techniques, e.g., the alkane/water mixture may be sprayed before, during or after aeration of the lawn with a conventional aeration machine. Alternatively, the alkane may be applied without water, e.g., with another carrier which allows the alkane to be sprayed or otherwise deposited on or in the lawn. Conventional lawn care equipment may also be retrofitted in accordance with the present invention to include the present alkane injection equipment.

While the alkane source may contain any higher order alkane such as methane, ethane or propane, or a combination thereof, butane is the preferred compound. The butane may contain straight (n-butane) and/or branched chain compounds such as iso-butane.

Butane is highly soluble and ideally suited to serve as a microbial growth substrate, thereby significantly increasing the heterogeneous microbial community in soil. The enhanced microbial population will rapidly absorb and mineralize the degradable and available dissolved organic nutrients in the organic matter, thus producing an organic mix that is very resistant to further microbial or enzymatic attack. The butane may be injected intermittently to create feeding/starvation cycles within the microbial community.

Butane enrichment increases the numbers of butane oxidizers in soil. Due to a high diversity among this type of bacteria, it is believed that butane or alkane enrichment will provide enhanced benefits to plant development and growth. Some members of this community such as Aeromonas caviae, Stenotrophomonas maltophilia, Micrococcus varians, Aureobacterium esteroaromaticum, Aureobacterium barkeri, Rhodococcus fascians, Nocardia paradoxus, Comamonas acidovorans and Pseudomonas aeruginosa, play a major role in the heterotrophic nitrification process. Thus, butane enrichment within the region of a plant rhizosphere may result in an increase in overall heterotrophic bacteria, a portion of which accelerate the heterotrophic nitrification process, thus providing overall benefits and accelerating plant growth.

Butane, as a gas, may be used to effectively stimulate plant or crop growth over a wide area, unlike the currently available products that are produced as powders or granular substances that are mixed with water. Butane is non-toxic. In fact, butane is a general-purpose food additive and is used in the food processing industry to extract vital oils and flavors from a variety of food sources, and is also used as an aerosol propellant for health care products that contact the skin.

In a preferred embodiment of the invention, alkane-utilizing bacteria are provided as a plant growth-enhancing additive. It is known that the addition of beneficial microorganisms to a soil mix, growing bed or crop may help prevent disease and increase plants' nutrient uptake, growth and development, and tolerance to stresses such as cold, heat and drought. Currently, many commercial growers use microbial enhancement/inoculation products that are available in the form of powder or concentrated liquid that is mixed with water, or in a granular form that is mixed into soil. Some products are mixed with nutrients that also increase the number of existing bacteria.

Plant roots provide suitable habitats for the growth of microorganisms, and particularly high numbers of many different microbial populations are found on and surrounding plant roots (rhizosphere). Interactions between soil microorganisms and plant roots satisfy important nutritional requirements for both the plant and the associated microorganisms.

Microbial populations in the rhizosphere may benefit plants in a variety of ways, including increased recycling and solubilization of mineral nutrients; synthesis of vitamins, amino acids, auxins and gibberellins, which stimulate plant growth; and antagonism with potential plant pathogens through competition and development of amensal relationships (detrimental to one while not adversely affecting the other) based on the production of antibiotics.

The present invention provides apparatus for the biostimulation of plant growth by introducing an alkane source into soil or other growth medium, or directly onto a plant. In one embodiment of the present invention, an alkane (and optionally air, water and/or plant growth-enhancing additives) may be injected into the soil of a potted plant. In another embodiment, an alkane (and optionally air, water and/or plant growth-enhancing additives) may be injected or sprayed into soil in which shrubs, trees or other plants are growing. In a further embodiment, an alkane (and optionally air, water and/or plant growth-enhancing additives) may be injected or sprayed on a lawn such as a residential lawn, commercial lawn or golf course. The lawn treatment may be performed in combination with watering and/or aeration treatments. In another embodiment of the invention, an alkane may be injected in lawns or crop fields using underground injection piping. For example, farms which currently employ underground injection methods for ammonia and fertilizer applications may be modified to inject butane into the root zone of crops using the network distribution piping. The immediate environment of plant root surfaces is referred to as the rhizoshere. When aerobic biostimulation is desired, such injection piping may also be supplied with an oxygen-containing gas such as air. Thus, alkane injection systems of the present invention may be newly installed in crop fields or retrofitted into crop fields with existing underground piping.

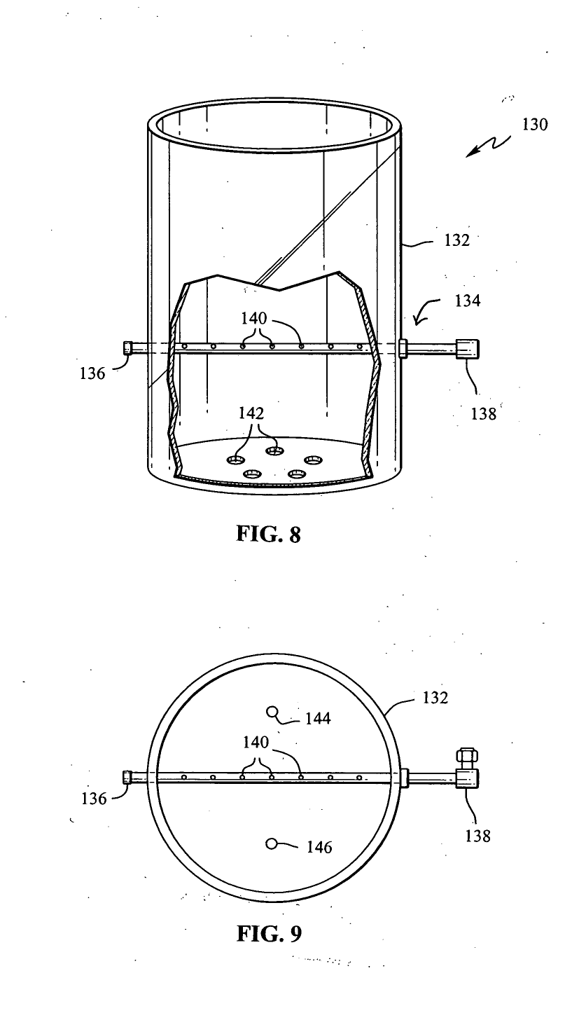

Referring to the drawings, FIG. 8 is a schematic representation of a plant growth vessel 130 including cylindrical container 132 constructed in accordance with an embodiment of the present invention. The container can be a Nalgene plastic container. A perforated butane injection tube 134 is positioned in the container and can pass through the container and can be sealed at one end, for example by a plug 136. The other end of the injection tube can include a syringe port 138 equipped with Teflon-coated septum for butane injections. A plurality of holes 140 are provided in the tube for the delivery of butane to the root zone of plants in the vessel. Drainage holes 142 can be provided in the bottom of the vessel.

FIG. 9 is a top view of the vessel of FIG. 8. Seed positions 144 and 146 show the approximate locations of seeds used in the examples discussed below.

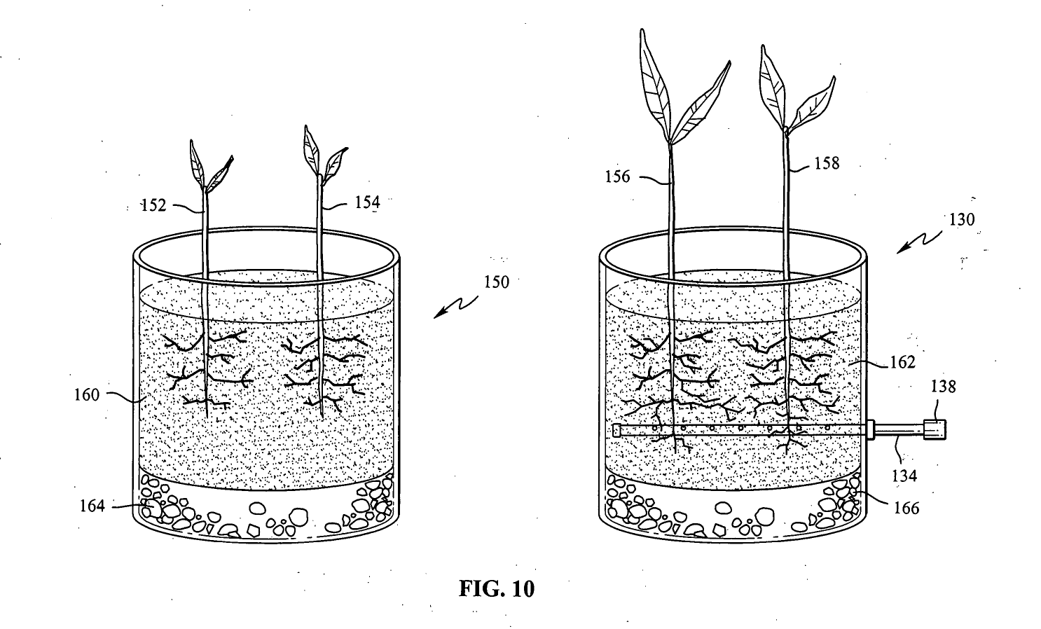

FIG. 10 is a schematic representation of a control vessel and an enhanced plant growth vessel, and illustrates enhanced plant growth produced by this invention. The control vessel 150 contains two seedlings 152, 154 that have been grown without the benefit of alkane injection. The enhanced plant growth vessel 130 contains two seedlings 156, 158 that were grown with the benefit of alkane injection. The control vessel 150 and the enhanced plant growth vessel 130 include soil 160 and 162 respectively, as well as gravel 164 and 166 for drainage.

In accordance with an embodiment of the present invention, injecting butane into the root zone of plants as a food source encourages the naturally occurring bacteria already acclimated to site conditions to flourish. Although not intending to be bound by any particular theory, butane injection may provide several benefits, as described in detail below.

Soil organic matter (SOM) is an accumulation of dead plant matter, partially decayed and partially resynthesized plant and animal residues, and live microbial and root matter. SOM contributes to plant growth through its effects on the chemical, biological and physical properties of soil. SOM supplies nitrogen, phosphorus and sulfur for plant growth, serves as an energy source for soil microfloral and macrofaunal organisms, and promotes good soil structure. SOM content is directly related to the sorption of most herbicides and many organic compounds. Organic chemicals associate with the organic fraction of soils. Thus SOM content strongly influences pesticide behavior in soil, including effectiveness against target species, phytotoxity to subsequent crops, leachability, volatility and biodegradability. Injecting butane in the root zone may increase SOM.

Humus is the organic portion of the soil remaining after microbial decomposition. Humus is a complex and rather microbially resistant mixture of brown to black, amorphous and colloidal substances modified from the original plant tissues or resynthesized by soil microorganisms. Humus affects soil structure. Aeration, water holding capacity and permeability are all favorably affected by humus. Butane injection will lead to an increase in soil microorganisms, which will lead to an increase in soil humus content.

Increases in bacteria may result in an increase in enzymes, nutrients and biochemical reactions/interactions with soil organic material (SOM) and humus that lead to the formation of additional compounds that are beneficial to plants. Butane enhancement and the resulting increase in bacteria may also lead to improvement in soil properties such as soil structure, aeration, water holding capacity and permeability, as well as the improved performance of herbicides, fungicides, pesticides and other agricultural chemicals.

The increases in soil bacteria and cell respiration due to butane injection may lead to increased amounts of carbon dioxide available to plants, which is used directly by plants during photosynthesis. Furthermore, butane injected into the root zone may also provide a direct benefit as a nutrient to plants.

Increased root growth due to butane injection may enable plants to reach groundwater at greater depths and thus enable plants to thrive under more harsh conditions, and in areas/climates where plants have not previously been able to thrive, or in less than optimal soil conditions.

Increased plant growth/plant size due to butane injection may lead to increased quantities of fruit, flowers, vegetables, legumes or grains produced by individual plants, or to increased size of individual fruit, flowers, ornamental flowers, vegetables, legumes or grains produced by plants.

Increased rate of seed germination due to butane injection may lead to increased numbers of plants produced by an individual seeding/planting event.

Increased plant ability to resist pests, diseases, lethal bacteria and fungi due to butane injection may lead to an increased survival rate of plants that will result in increased production of plants, fruit, flowers, vegetables, legumes or grains during a growing season.

Increased rate of plant growth due to butane injection may lead to an increased number of possible cycles of individual seedings/planting events followed by growth period and harvesting events within an individual growing season, with the possibility of producing the outcome of two growing seasons in one.

Increased plant ability to endure stress, such as cold, heat or drought due to butane injection may lead to a longer growing season.

Increased plant size or number of plants due to butane injection into the root zone may lead to increased production of oxygen in the atmosphere resulting from the process of photosynthesis.

Butane may be injected, for example, through existing piping networks that deliver nutrients and agricultural chemicals to the soil subsurface. Butane may be injected alone, simultaneously or intermittently with other nutrients or chemicals. Butane may also be injected simultaneously or intermittently with air or other gases.

Butane may be injected into all soil types, including soil-less mixtures used for growing plants. Butane may be injected into the root zone of plants grown outdoors or in greenhouses. Butane may be injected into hydroponic and aeroponic growing systems, which use no soil. Butane may be injected into aquatic growing systems, such as seaweed or kelp beds, and semi-aquatic growing systems or fields, such as puddled rice fields or paddies.

The present method of butane enhanced plant growth may be applied to all plants, grasses, trees, shrubs, vines, fruit, flowers, legumes, grains and mosses in the Kingdom Plantae, for example, flowering monocot and dicot plants (phyla Angiospermophyta, class Monocotyledoneae, class Dicotylodoneae,); conifers (phyla Ginkgophyta, Gnetophyta, Cycadophyta and Coniferophyta); non vascular plants including mosses (phylum Bryophyta), liverworts (phylum Hepatophyta), hornworts (phylum Anthoceraphyta); and ferns (phyla Filicinophyta, Sphenophyta, Lycodophyta and Psilophyta).

Many plants are dependent on the help of fungi to get nutrients, and live in a symbiotic relationship with fungi called mycorrhizal association. They obtain food by absorbing dissolved inorganic and organic materials. They digest food outside their bodies. Typically a fungus will secret digestive enzymes onto a food source and absorb the smaller molecules released. Mycorrhizal associates (plants) benefit from this by absorbing materials digested by the fungi growing among their roots.

Enhanced uptake of water and mineral nutrients, particularly phosphorus and nitrogen, has been noted in many mycorrhizal associations. Plants with mycorrhizal fungi are therefore able to occupy habitats they otherwise could not. The importance of mycorrhizal association was first recognized in connection with efforts to grow orchids in greenhouses. Orchids have microscopic seeds that germinate to form a tiny pad of tissue called a protocorm. Cultivaters of orchids found that the plants seldom developed beyond the protocorm stage unless they were infected by a particular kind of fungus. It has also been found that if seedlings of forest trees are grown in nutrient solutions and then transplanted to prairie and other grassland soils they fail to grow. Eventually they die from malnutrition despite the fact that soil analysis shows that there are abundant nutrients in the soil. If a small amount of forest soil containing fungi is added around the roots of the seedlings, however, they will grow promptly and normally. The fungus may form a sheath around the root. The role of water and mineral uptake of the root is partially assumed by the fungi. Butane injection leads to an increase in SOM, and therefore an increased food source for fungi, which provide benefits for increased plant growth. Increased plant growth may indicate that butane injection in the root zone may be used directly as a nutrient by fungi, or may stimulate conditions that lead to improved growth of fungi and improved performance during mycorrhizal association.

Butane injection increases numbers of indigenous bacteria in soil and water. These bacteria produce carbon dioxide during respiration. Some protists use carbon dioxide as a food source during photosynthesis. Increased availability of carbon dioxide may lead to increased numbers of protists or increased size of protists, or increased ability of protists to thrive under conditions of stress, in climates or environments where protists do not usually thrive. Butane injection may be used directly as a nutrient by protists, or may stimulate conditions that lead to improved growth of protists.

Bacteria utilized in accordance with the biostimulation methods of the present invention may include the following Groups (in addition to fungi, algae, protozoa, rotifers and other aerobic and anaerobic microbial populations found in decaying materials):
Group 1: The Spirochetes
Group 2: Aerobic/Microaerophilic, motile, helical/vibroid, gram-negative bacteria
Group 3: Nonmotile (or rarely motile), gram-negative bacteria
Group 4: Gram-negative aerobic/microaerophilic rods and cocci
Group 5: Facultatively anaerobic gram-negative rods
Group 6: Gram-negative, anaerobic, straight, curved, and helical bacteria
Group 7: Dissimilatory sulfate- or sulfur-reducing bacteria
Group 8: Anaerobic gram-negative cocci
Group 9: Anoxygenic phototrophic bacteria
Group 10: Oxygenic phototrophic bacteria
Group 11: Aerobic chemolithotrophic bacteria and associated organisms
Group 12: Budding and/or appendaged bacteria
Group 13: Sheathed bacteria
Group 14: Nonphotosynthetic, nonfruiting gliding bacteria
Group 15: The fruiting, gliding bacteria and the Myxobacteria
Group 16: Gram-positive cocci
Group 17: Endospore-forming gram-positive rods and cocci
Group 18: Regular, nonsporing, gram-positive rods
Group 19: Irregular, nonsporing, gram-positive rods
Group 20: The mycobacteria
Groups 21-28: The actinomycetes
Group 21: Nocardioform actinomycetes
Group 22: Genera with multiocular sporangia
Group 23: Actinoplanetes
Group 24: Streptomycetes and related genera
Group 25: Maduromycetes
Group 26: Thermomonospora and related genera
Group 27: Thermoactinomycetes
Group 28: Genus Glycomyces, Genus Kitasatospira and Genus Saccharothrix
Group 29: The Mycoplasmas - cell wall-less bacteria
Group 30: The Methanogens
Group 31: Archaeal sulfate reducers
Group 32: Extremely halophilic, archaeobacteria (halobacteria)
Group 33: Cell wall-less archaeobacteria
Group 34: Extremely thermophilic and hyperthermophilic S⁰-metabolizers

In addition to the above-listed bacteria examples, facultative anaerobes and microaerophilics, which are bacteria capable of surviving at low levels of oxygen, may also be used in accordance with the present invention. They do not require strict anaerobic conditions such as the obligate anaerobes. Examples include acidophilic, alkaliphilic, anaerobe, anoxygenic, autotrophic, chemolithotrophic, chemoorganotroph, chemotroph, halophilic, methanogenic, neutrophilic, phototroph, saprophytic, thermoacidophilic and thermophilic bacteria.

### EXAMPLE 1

On Day No. 1, two Nalgene plastic vessels (one for butane enhanced growth and one for control) approximately 11 cm in diameter and 6.5 cm deep were prepared with 0.4 cm drainage holes drilled in each base. The butane enhanced growth vessel (illustrated in FIG. 8) was prepared with a 12 cm section of Teflon tubing sealed outside the vessel at one end and connected at the other end to a syringe port equipped with Teflon-coated septum for butane injections. The tubing intersected the vessel through the diameter at a height of 1.5 cm above the base. Nine butane injection holes were placed at 1 cm intervals along the tubing inside the vessel. Each vessel was filled with approximately 523 cm³ of Iowa Crop Soil (soil depth =5.5 cm) that had been collected from an Iowa commercial cornfield. The soil in each vessel was tested for pH using a Chemetrics pH meter dipped in a mixture of 40 ml distilled water and 100 grams of soil. Soil tests returned pH of 7.2 in both vessels.

Each vessel was seeded with two seeds of sweet corn, variety Sugar Dots, placed (illustrated in FIG. 9) at a depth of 2.54 cm below soil surface. Each vessel was then watered with 100 ml spring water and positioned on its own drainage tray on a shelf approximately 10 cm below two 33 watt grow light tubes (no sunlight) equipped with a timer set for 16 hours light on, 6 hours light off. White reflective covering was placed on the wall immediately behind the samples, with an aluminum foil hood extending over the light fixture to reflect light downward onto the vessels.

Ambient temperature was recorded, water was sprinkled evenly over the soil surface of each vessel, and n-butane was injected into the root zone (rhizosphere) through the syringe port of the butane enhanced growth vessel according to the regimen in Table 1.

TABLE 1
Butane Injection Schedule

| | | | | Ambient |
|---|---|---|---|---|
| Day No. | Time | Volume of Butane | Water added | Temperature |
| 1 | 13:30 | 50 ml | 100 ml | 76° |
| 2 | 10:47 | 50 ml | N/A | 74° |
| 2 | 13:30 | 50 ml | N/A | 74° |
| 5 | 16:30 | 100 ml | 50 ml | 76° |
| 6 | 12:30 | 100 ml | 50 ml | 78° |
| 7 | 13:15 | 50 ml | N/A | 76° |
| 7* | 18:00 | 100 ml | 50 ml | 76° |
| 8 | 13:00 | 100 ml | N/A | 76° |
| 8 | 18:00 | 100 ml | N/A | 76° |
| 9 | 10:30 | 100 ml | N/A | 76° |

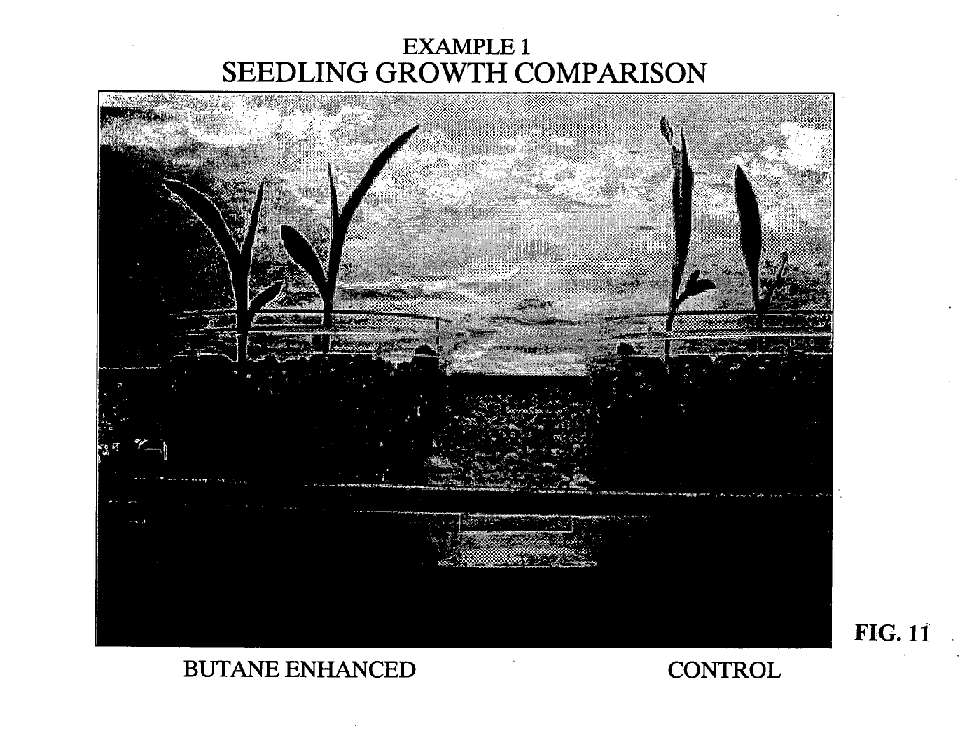

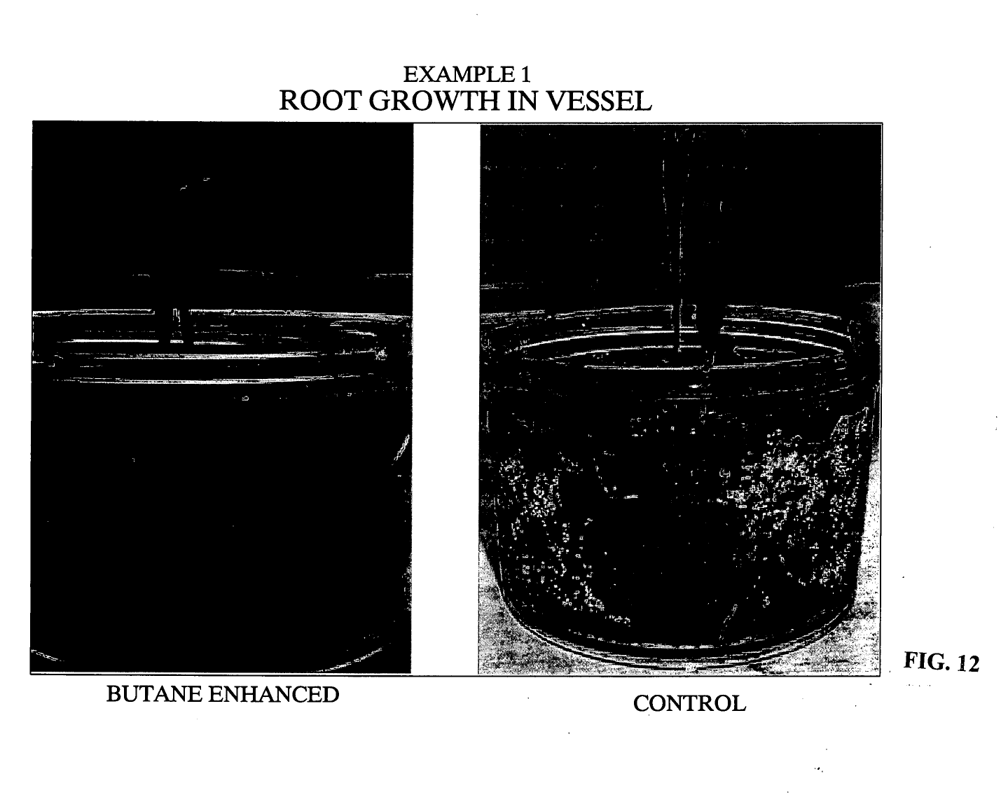

Seedling height for the last four days of growth is recorded in Table 2. FIG. 11 is a photograph of the butane enhanced and control seedlings of Example 1, and FIG. 12 is a photograph of root growth for the seedlings.

TABLE 2
Seedling Height

| Sweet Corn | | |
|---|---|---|
| Sugar Dots | Butane Enhanced | |
| Day No. | Growth | Control |
| 1 | — | — |
| 2 | — | — |
| 3 | — | — |
| 4 | — | — |
| 5 | — | — |
| 6 | 0.5 cm, 0.8 cm | 0.5 cm, 1.0 cm |
| 7 | 4.0 cm, 4.5 cm | 5.0 cm, 5.5 cm |
| 8 | 7.0 cm, 6.0 cm | 6.8 cm, 6.5 cm |
| 9 | 11.0 cm, 6.8 cm | 8.8 cm, 9.8 cm |

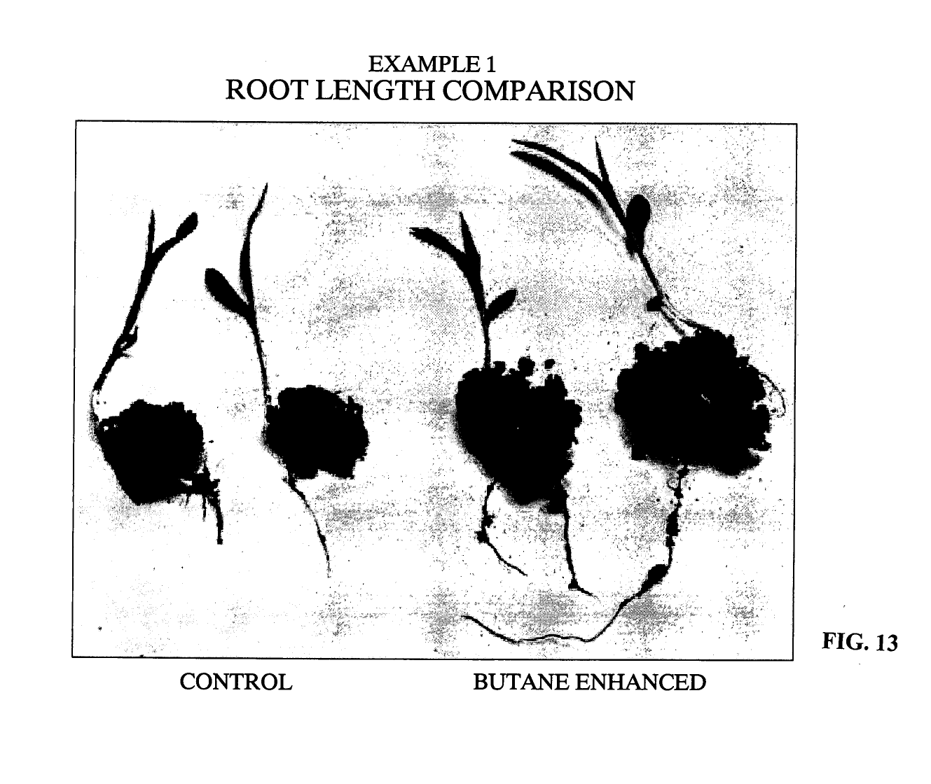

On Day No. 9, all four plants (two butane enhanced growth and two control) were unearthed to the extent possible without damaging the root system to reveal the root ball (roots and soil clinging to roots) and longest roots of each plant. FIG. 13 is a photograph of the unearthed plants of Example 1.

On the last four days of growth, water droplets were observed clinging to the leaves of the butane-enhanced plants.

The root systems of the butane enhanced and control plants were visible through the sides of the clear grow vessels, as shown in the photograph of FIG. 12. The roots of the butane-enhanced plants were observed to spread to a greater and more complex degree horizontally than the roots of the control plants. Unearthing of the four plants (FIG. 13) revealed that the two butane-enhanced plants had longer roots (25 cm and 12 cm) and larger roots ball than the two control plants (11 cm and 8 cm). The root branches of the butane enhanced plants also appeared to be longer and greater in number than the root branches of the control plants. The thickness and color (grayish white) of the roots appeared to be the same in the butane-enhanced and control plants.

The butane-enhanced plants each grew to a maximum of 11 cm and 6.8 cm in height. The control plants reached heights of 8.8 cm and 9.8 cm on the final day of growth.

### EXAMPLE 2

On Day No. 1, two Nalgene vessels, (one for butane enhanced growth and one for control) approximately 11 cm in diameter and 13 cm deep, were prepared with five 0.4 cm drainage holes drilled in each base. The butane enhanced growth vessel (illustrated in FIG. 8) was prepared with a 12 cm section of Teflon tubing sealed outside the vessel at one end and connected at the other end to a syringe port equipped with Teflon-coated septum for butane injections. The tubing intersected the vessel through the diameter at a height of 3.5 cm above the base. Nine butane injection holes were placed at 1 cm intervals along the tubing inside the vessel. Each vessel was filled with approximately 902 cm³ of Iowa Crop Soil (soil depth =9.5 cm) that had been collected from an Iowa commercial cornfield. The soil in each vessel was tested for pH using a Chemetrics pH meter dipped in a mixture of 40 ml distilled water and 100 grams of soil. Soil tests returned pH of 7.2 in both vessels.

Each vessel was seeded with two seeds of sweet corn, variety Sugar Dots, (using the seed positions shown in FIG. 9) placed at a depth of 2.54 cm below soil surface. Each vessel was then watered with 100 ml spring water and positioned on its own drainage tray on a shelf approximately 10 cm below three 33 watt grow light tubes (no sunlight) equipped with a timer set for 16 hours light on, 6 hours light off. White reflective covering was placed on the wall immediately behind the samples, with an aluminum foil hood extending over the light fixture to reflect light downward onto the vessels.

Ambient temperature was recorded, water was sprinkled evenly over the soil surface of each vessel, and n-butane was injected into the root zone through the syringe port of the butane enhanced growth vessel according to the regimen in Table 3.

TABLE 3
Butane Injection Schedule

| | | | | Ambient |
|---|---|---|---|---|
| Day No. | Time | Volume of Butane | Water added | Temperature |
| 1 | 13:00 | 100 ml | 100 ml | 78° |
| 1 | 18:00 | 100 ml | N/A | 78° |
| 2 | 08:00 | 100 ml | N/A | 74° |
| 2 | 13:00 | 100 ml | N/A | 76° |
| 2 | 09:26 | 100 ml | 50 ml | 74° |
| 3 | 14:00 | 100 ml | N/A | 76° |
| 3* | 18:25 | 100 ml | N/A | 76° |
| 4 | 08:35 | 100 ml | N/A | 74° |
| 4 | 13:30 | 100 ml | N/A | 76° |
| 4 | 18:30 | 100 ml | N/A | 76° |
| 5 | 15:50 | 100 ml | N/A | 74° |
| 5 | 17:45 | 50 ml | N/A | 74° |
| 6 | 19:10 | 100 ml | 40 ml | 72° |
| 6 | 20:35 | 50 ml | N/A | 74° |
| 7 | 08:10 | 100 ml | N/A | 68° |
| 7 | 13:00 | 100 ml | N/A | 72° |
| 7 | 18:30 | 100 ml | N/A | 72° |
| 8 | 09:00 | 100 ml | N/A | 74° |
| 8 | 16:15 | 100 ml | N/A | 76° |
| 8 | 20:00 | 100 ml | 50 ml | 76° |
| 9 | 09:20 | 100 ml | N/A | 76° |
| 9 | 13:30 | 100 ml | N/A | 76° |
| 9 | 18:30 | 100 ml | N/A | 76° |
| 10 | 07:30 | 100 ml | N/A | 74° |
| 10 | 12:30 | 100 ml | N/A | 74° |
| 10 | 18:30 | 100 ml | N/A | 74° |
| 11 | 09:30 | 100 ml | N/A | 74° |
| 11 | 12:45 | 100 ml | N/A | 82° |
| 11 | 20:00 | 100 ml | 50 ml | 82° |
| 12 | 09:35 | 100 ml | N/A | 74° |
| 12 | 13:00 | 100 ml | N/A | 74° |
| 12 | 18:00 | 100 ml | N/A | 74° |
| 13 | 18:20 | 150 ml | N/A | 68° |
| 14 | 07:50 | 100 ml | N/A | 58° |
| 14 | 11:30 | 100 ml | N/A | 68° |
| 14 | 18:30 | 100 ml | N/A | 68° |
| 15 | 07:30 | 100 ml | N/A | 57° |
| 15 | 13:30 | 100 ml | N/A | 68° |
| 15 | 19:30 | 100 ml | 50 ml | 68° |
| 16 | 07:30 | 100 ml | N/A | 60° |
| 16 | 13:00 | 100 ml | N/A | 64° |
| 16 | 19:00 | 100 ml | N/A | 68° |

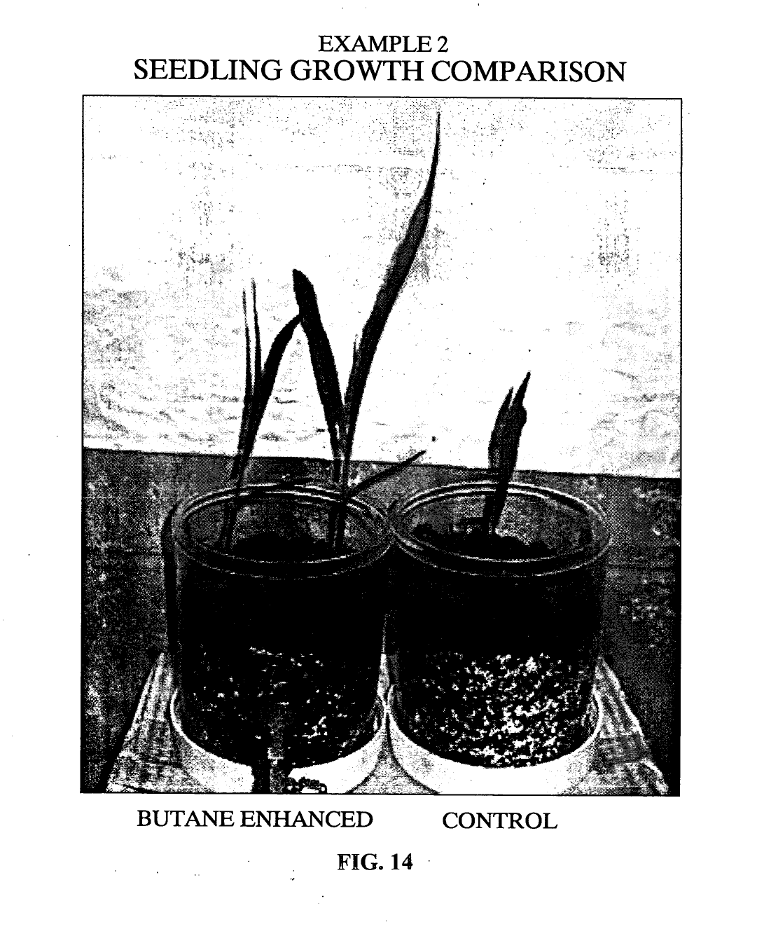

Plant growth was observed for sixteen days. Seedling height is recorded in Table 4. FIG. 14 is a photograph showing the seedlings of Example 2.

TABLE 4
Seedling Height

| Sweet Corn | | Control |
|---|---|---|
| Sugar Dots | Butane Enhanced | (Only 1 seed |
| Day No. | Growth | sprouted) |
| 1 | — | — |
| 2 | — | — |
| 3 | — | — |
| 4 | — | — |
| 5 | 0.5 cm, 1.0 cm | — |
| 6 | 3.0 cm, 3.0 cm | — |
| 7 | 4.0 cm, 4.0 cm | — |
| 8 | 6.0 cm, 5.7 cm | 0.8 cm |
| 9 | 8.0 cm, 7.2 cm | 2.7 cm |
| 10 | 11.0 cm, 9.1 cm | 4.0 cm |
| 11 | 16.0 cm, 12 cm | 6.5 cm |
| 12 | 18.0 cm, 15.5 cm | 8.2 cm |
| 13 | 19.0 cm, 16.7 cm | 8.9 cm |
| 14 | 20.1 cm, 17.3 cm | 9.6 cm |
| 15 | 22.0 cm, 18.0 cm | 11.0 cm |
| 16 | 27.0 cm, 19.6 cm | 15.0 cm |

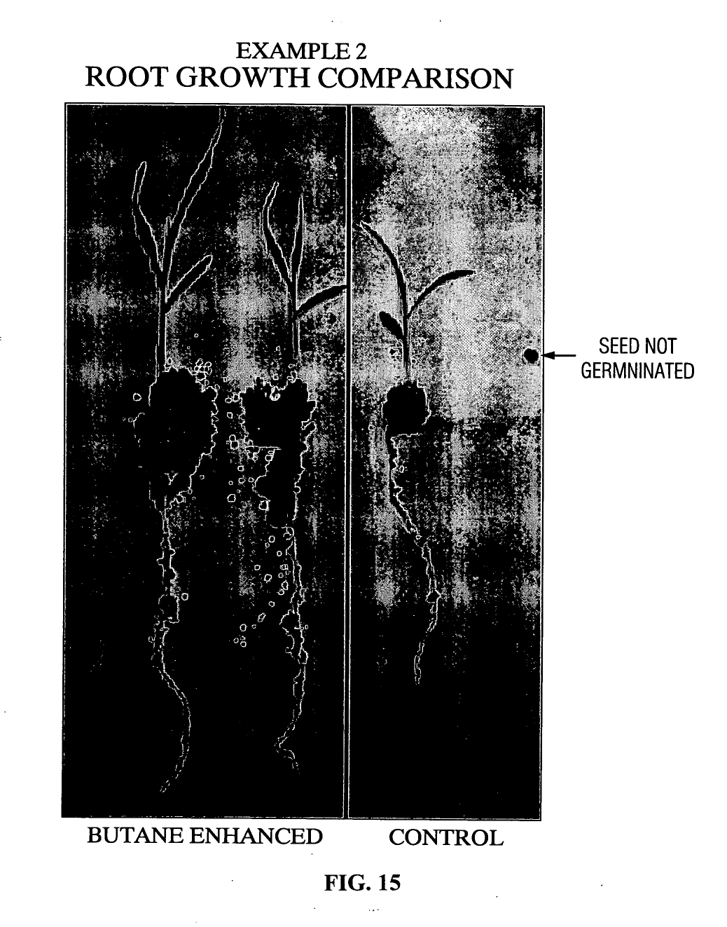

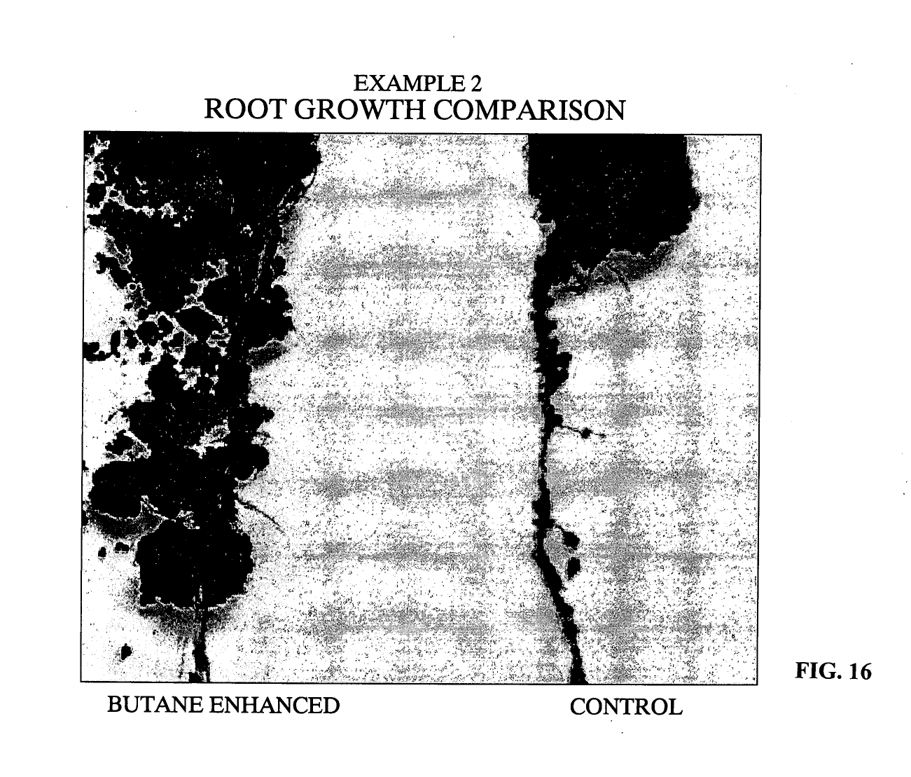

On Day No. 16, all three corn plants (two butane enhanced growth and one control) were unearthed to the extent possible without damaging the root system to reveal the root ball (roots and soil clinging to roots) and longest roots of each plant. FIGS. 15 and 16 show the unearthed seedlings of Example 2.

The two corn seeds planted in the butane enhanced growth vessel sprouted into seedlings, while only one of the seeds planted in the control vessel (no butane) sprouted. One seed in the control vessel never germinated, with the seed coat observed to be still firm and unbroken when unearthed on Day No. 16. The butane enhanced plants sprouted three days earlier than the control plant.

Soil moisture content in the butane enhanced growth and control vessels remained high throughout the experiment. All plants received the same amount of water. The significant increase in growth rate and size of the butane enhanced plants over the one sprouted control plant did not appear to result in an increase in the rate of “drying out” of the soil, perhaps indicating that butane enhancement increases soil capacity to hold water.

The leaves of the butane enhanced corn plants and the control corn plant exhibited the same color (medium green) and shape, while the stems of all plants were light green with a purplish tint near the base of the stem. On the last day of growth the stems of the butane enhanced plants were 0.5 cm (taller plant) and 0.3 cm (shorter plant) in thickness. The stem of the control plant was 0.25 cm in thickness.

The control corn plant grew at an average rate of 0.94 cm per day over the sixteen-day period, while the butane enhanced corn plants grew at an average rate of 1.45 cm per day. The butane enhanced plants exhibited a 54% faster growth rate than the control plant. The control plant achieved growth in height of 15.0 cm, while the butane enhanced plants achieved an average growth in height of 23.3 cm. The butane enhanced corn plants grew to an average height 55% taller than the control corn plant.

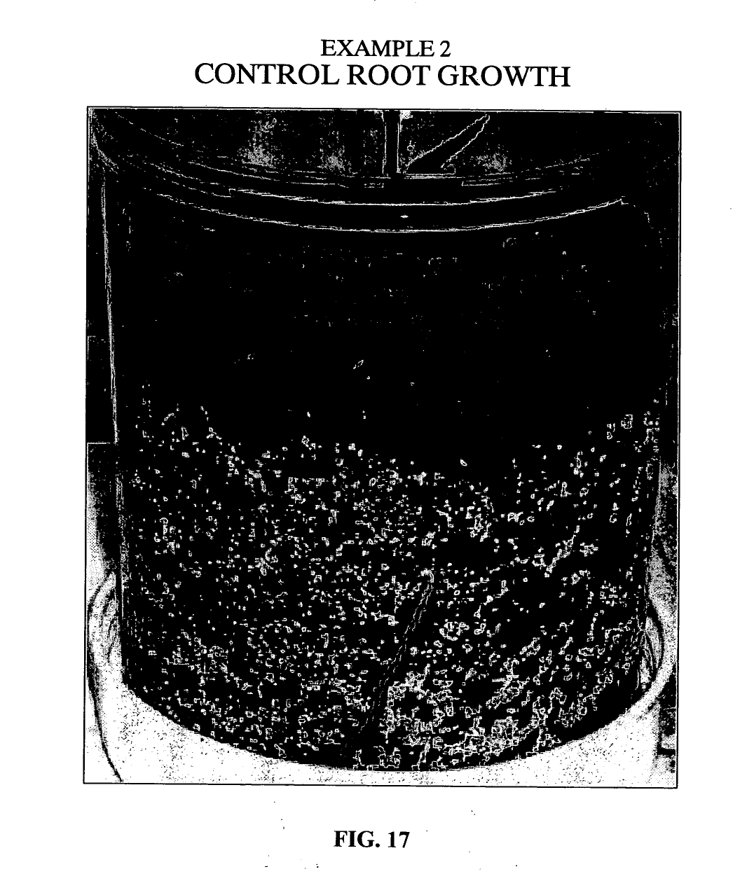

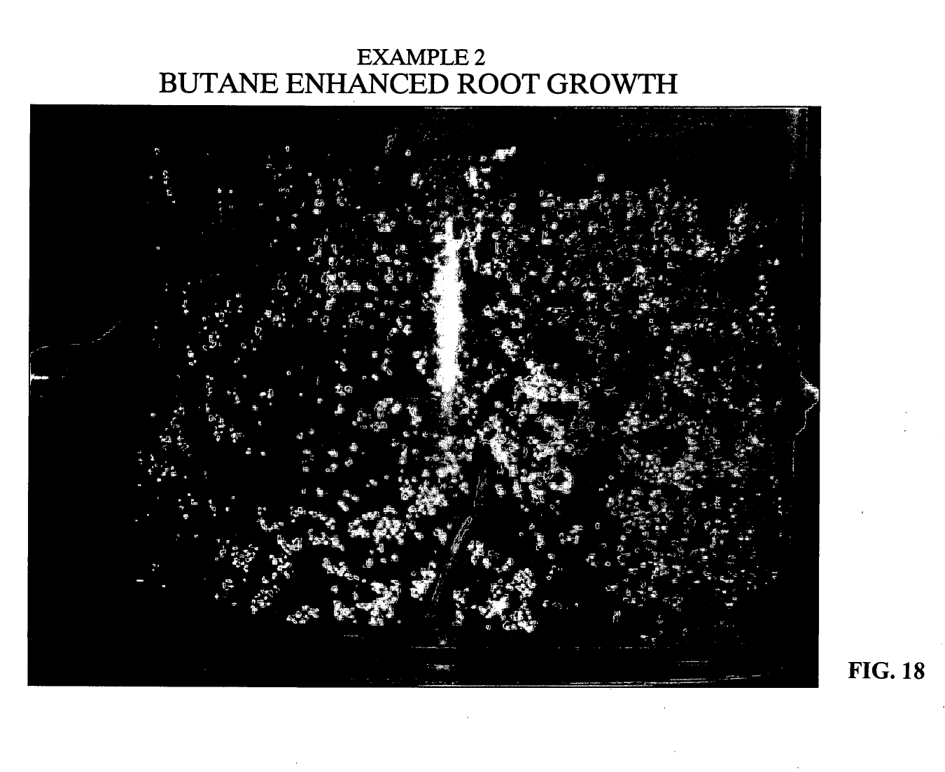

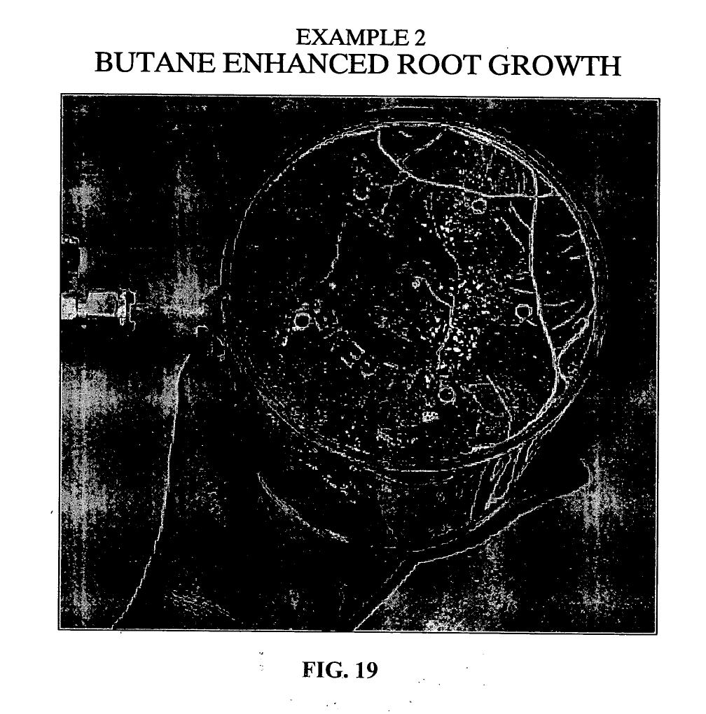

Roots of the butane enhanced plants and the control plant were visible through the clear vessels. The main root of the control plant was observed to have tiny root branches shorter than 0.25 cm (as shown in FIG. 17). The main roots of the butane enhanced plants were observed to be of the same thickness as that of the control plant. However, the root branches of the butane enhanced plants were observed to be longer, up to 3 cm in length (as shown in FIGS. 18 and 19).

After the plants were unearthed and soil was removed to the extent possible without damaging the roots, the main (longest) roots of all plants were compared and measured (approximately due to presence of remaining soil). FIGS. 15 and 16 show the unearthed plants of Example 2. The main roots of the butane enhanced plants were longer than the control plant main root. The main root of the taller (27 cm) butane enhanced plant was approximately 30 cm in length, while that of the shorter (19.6 cm) butane enhanced plant was approximately 25 cm long. The main root of the control plant was approximately 20 cm long. Again, the root branches of the butane enhanced plants were longer and greater in number than those of the control plant (as shown in FIGS. 15 and 16).

In both Examples 1 and 2, butane injection is associated with growth of longer and more complex root systems in sweet corn plants, variety Sugar Dots. In both Examples 1 and 2, water droplets were observed on several days following watering events. This “sweating” activity of the plant is probably due to absorption of excess water by the expanding root system resulting from butane treatment.

Although the results achieved in Example 1 were inconclusive regarding the advantage in height of butane enhanced plants over the control plants, the outcome of Example 2, in which increased amounts of butane were injected into the root zone, clearly showed the butane enhanced plants significantly surpassed the control plant in average growth rate and average growth in height.

### EXAMPLE 3

### Gladioli Bulb Experiment

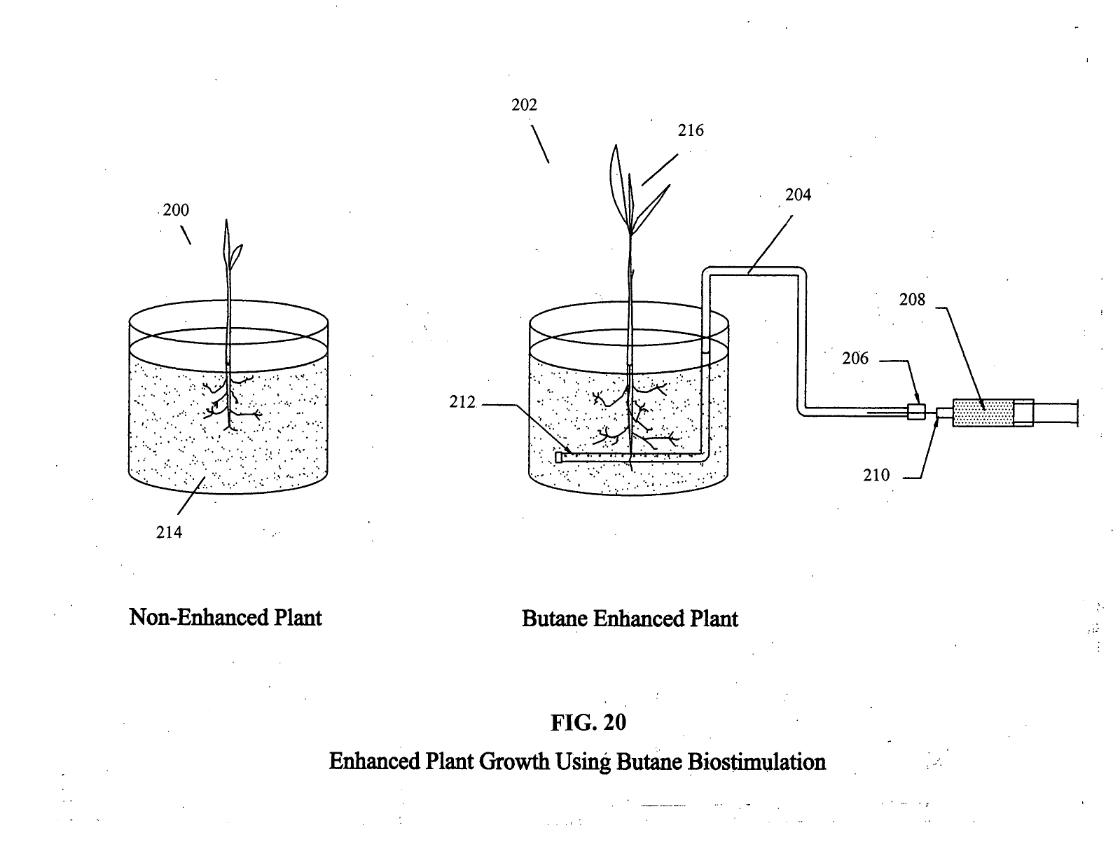

Four Nalgene plastic vessels (two for butane enhanced growth and two for controls), each approximately 11 cm. in diameter and 12 cm. deep, were prepared with three 0.4 cm drainage holes drilled in each base. FIG. 20 depicts one control vessel 200 and one butane enhanced growth vessel 202. Each butane enhanced growth vessel 202 was prepared with a 12 cm section of Teflon tubing 204 and connected at one end to a syringe port 206 equipped with Teflon-coated septum for injections of butane 208 using a syringe 210. Nine butane injection holes 212 were placed at 1 cm intervals along the tubing 204 inside the vessel 202. Each vessel was filled with approximately 800 cm³ of Pro-Mix® Potting Soil 214.

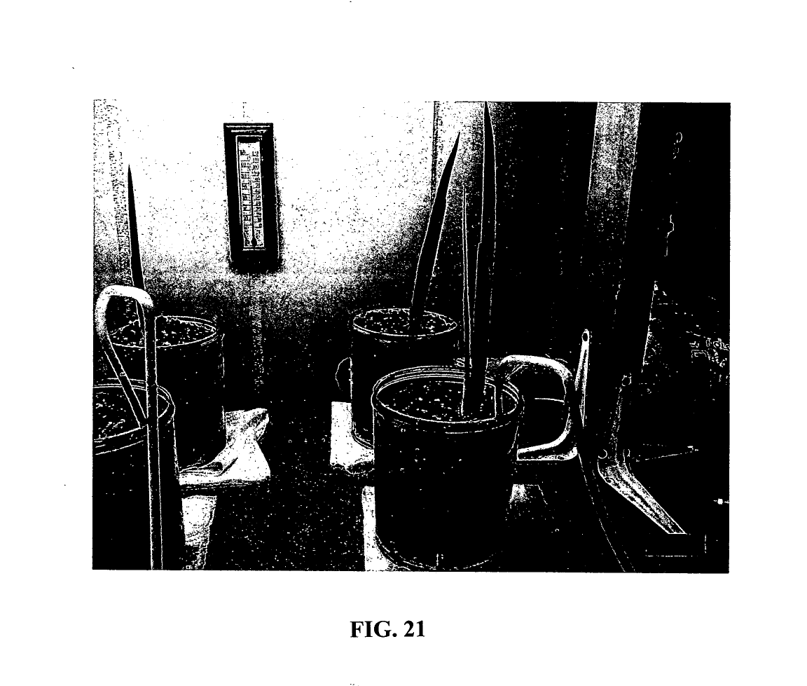

Each vessel contained one Gladioli bulb 216 placed at a depth of 10 cm below soil surface. FIG. 21 is a photograph showing the bulbs and vessels. Each vessel was then watered with 100 ml spring water and positioned on its own drainage tray on a shelf approximately 60 cm below two 33 watt grow light tubes (no sunlight) equipped with a timer set for 16 hours light on, 6 hours light off.

Ambient temperature was recorded, water was sprinkled evenly over the soil surface of each vessel, and n-butane was injected into the root zone (rhizosphere) through the syringe port of the butane enhanced growth vessel according to the regimen shown in Table 5.

TABLE 5
Butane Injection Schedule - Gladioli Bulb Experiment

| | | | | Ambient |
|---|---|---|---|---|
| Day No. | Time | Volume of Butane | Water Added | Temperature |
| 1 | 19:28 | 100 ml | 100 ml | 20° C. |
| 2 | 19:22 | 100 ml | 100 ml | 20° C. |
| 3 | 19:25 | 100 ml | none | 16.5° C. |
| 4 | 13:39 | 100 ml | none | 18.5° C. |
| 5 | — | — | — | — |
| 6 | 19:30 | 100 ml | none | 18.5° C. |
| 7 | 18:30 | 100 ml | none | 19.0° C. |
| 8 | — | — | — | — |
| 9 | 19:00 | 100 ml | 50 ml | 20.0° C. |
| 10 | 18:30 | 100 ml | None | 20.0° C. |
| 12 | 19:30 | 200 ml | None | 20.0° C. |
| 14 | 16:30 | 100 ml | 50 ml | 20.0° C. |
| 15* | 20:00 | 100 ml | none | 19.0° C. |
| 16 | 15:00 | 120 ml | 100 ml | 20.5° C. |
| 18 | 11:30 | 120 ml | None | 19.5° C. |

| | |
|---|---|
| 19 | The experiment was halted. Liquid butane injected |
| | into the rhizosphere killed the |
| | growing plants. |

— not recorded
*first sign of growth above the soil surface

### EXAMPLE 4

### Gladioli Bulb Experiment

Since the Gladioli plants were killed by liquid butane injection, a new growth experiment was initiated. Once again, four Nalgene plastic vessels (two for butane enhanced growth and two for controls), each approximately 11 cm. in diameter and 12 cm. deep, were prepared with three 0.4 cm drainage holes drilled in each base. Each butane enhanced growth vessel was prepared with a 12 cm section of Teflon tubing as and connected at one end to a syringe port equipped with Teflon-coated septum for butane injections through a syringe. Nine butane injection holes were placed at 1 cm intervals along the tubing inside the vessel. Each vessel was filled with approximately 800 cm³ of Pro-Mix® Potting Soil (see FIGS. 20 and 21).

Each vessel contained one Gladioli bulb placed at a depth of 10 cm below soil surface. Each vessel was then watered with 100 ml spring water and positioned on its own drainage tray on a shelf approximately 60 cm below two 33 watt grow light tubes (no sunlight) equipped with a timer set for 16 hours light on, 6 hours light off.

Ambient temperature was recorded, water was sprinkled evenly over the soil surface of each vessel, and n-butane was injected into the root zone (rhizosphere) through the syringe port of the butane enhanced growth vessel according to the regimen shown in Table 6.

TABLE 6
Butane Injection Schedule - Gladioli Bulb Experiment

| | | | | Ambient |
|---|---|---|---|---|
| Day No. | Time | Volume of Butane | Water Added | Temperature |
| 1 | 17:30 | 60 ml | 100 ml | 20° C. |
| 2 | 15:00 | 60 ml | 100 ml | 20° C. |
| 3 | 15:20 | 60 ml | 100 ml | 20.0° C. |
| 4 | 11:20 | 60 ml | 100 ml | 19.0° C. |
| 6 | 14:00 | 60 ml | 100 ml | 21.0° C. |
| 7 | 17:15 | 60 ml | none | 21.0° C. |
| 8 | 13:15 | 60 ml | none | 21.0° C. |
| 9 | 15:15 | 145 ml | 50 ml | 21.0° C. |
| 10 | 19:00 | 145 ml | none | 21.0° C. |
| 13 | 10:45 | 150 ml | none | 19.0° C. |
| 14* | 20:00 | 150 ml | none | 20.0° C. |
| 15 | 13:45 | 150 ml | 100 ml | 22.0° C. |
| 16 | 20:45 | 150 ml | none | 20.0° C. |
| 17 | 19:05 | 180 ml | 50 ml | 20.0° C. |
| 18 | 15:30 | 150 ml | none | 23.0° C. |
| 19 | 13:59 | 120 ml | none | 23.0° C. |
| 20 | | | | |

| | |
|---|---|
| 21 | Experiment halted and bulbs unearthed. |

*first sign of growth above the soil surface

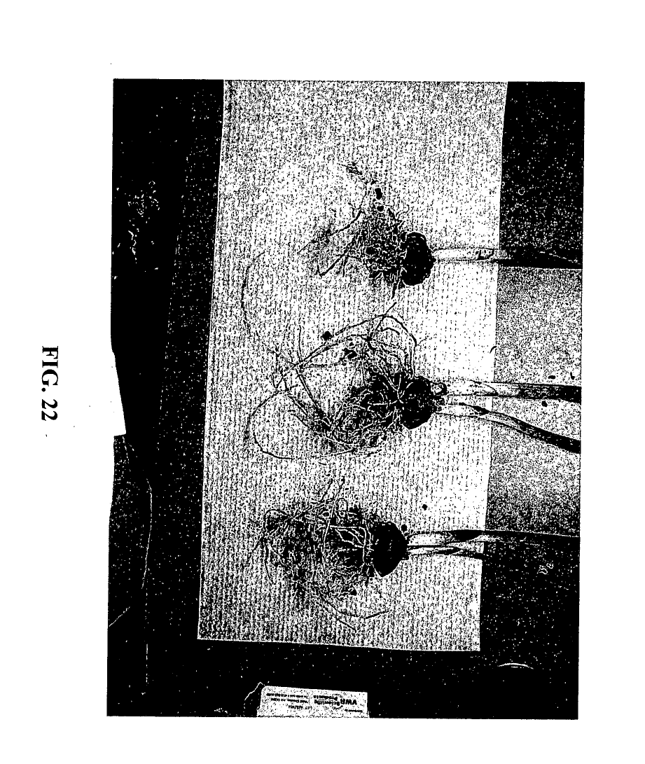

On Day No. 18, all four plants (two butane enhanced growth and two control) were unearthed to the extent possible without damaging the root system to reveal the root bulb (FIG. 22).

Two of the plants shown in FIG. 21 (the two on the right) had undergone butane enrichment for a period of 17 days. The left plant was the control. The second control (not shown) was nearly identical to the one shown. The root development in the two butane enrichment bulbs was greater than the root development in the control plant. All three plants were Gladioli and the bulbs used for the experiment were of very similar size and growth development prior to beginning the experiment. Of special note is the bifurcation noted in the butane enhanced bulbs. This is extremely unusual for bulb growth and development. In most normal growth circumstances, the primary shoot extends above the soil line before bifurcating and the secondary shoot extends off of the primary shoot. They do not extend directly from the bulb sphere. By injecting with butane gas, the bulbs were apparently conditioned to grow two plants. All of the butane enhanced shoots grew directly from the bulb sphere.

As shown in Table 7, the butane-enhanced bulbs each grew to a maximum of 27.0 cm and 29.0 cm in height for the primary shoots and 14.0 and 23.0 cm for the secondary shoots. The control plants reached heights of 22.0 cm and 28.0 cm on the final day of growth. However, it should be noted that the butane enhanced bulbs supported the growth of two plants as opposed to one.

TABLE 7
Seedling Height

| | | | Control | |
|---|---|---|---|---|
| Day No. | Butane Bulb 1 | Butane Bulb 2 | Bulb 2 | Control Bulb 2 |
| 1 | 5.0 cm | Main shoot 7.0 cm | 3.0 cm | 5.0 cm |
| | | Secondary shoot 3.0 cm | | |
| 2 | Main shoot 7.5 cm | Main shoot 10.0 cm | 4.6 cm | 7.0 cm |
| | Secondary shoot 0.5 cm | Secondary shoot 5.5 cm | | |
| 3 | Main shoot 14.0 cm | Main shoot 15.5 cm | 9.5 cm | 11.0 cm |
| | Secondary shoot 3.5 cm | Secondary shoot 10.5 cm | | |
| 4 | Main shoot 18.5 cm | Main shoot 19.5 cm | 13.0 cm | 16.0 cm |
| | Secondary shoot 6.0 cm | Secondary shoot 14.0 cm | | |
| 5 | Main shoot 23.0 cm | Main shoot 24.0 cm | 17.0 cm | 21.5 cm |
| | Secondary shoot 10.0 cm | Secondary shoot 18.0 cm | | |
| 6 | Main shoot 27.0 cm | Main shoot 29.0 cm | 22.0 | 28.0 |
| | Secondary shoot 14.0 cm | Secondary shoot 23.0 cm | | |

### EXAMPLE 5

### Method of Butane Enhanced Sunflower Plant Growth in Sand

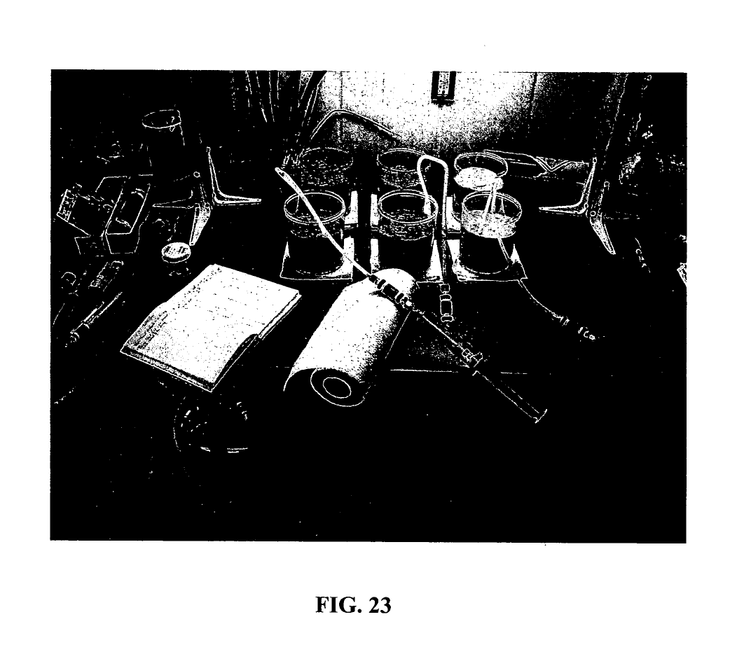

An experiment was conducted to determine if butane enrichment could support luxurious plant growth in sand where very little organic material is available. Six Nalgene plastic vessels (three for butane enhanced growth and three for controls), each approximately 11 cm. in diameter and 12 cm. deep, were prepared with three 0.4 cm drainage holes drilled in each base. Each butane enhanced growth vessel was prepared with a 12 cm section of Teflon tubing as shown in FIG. 23 and connected at one end to a syringe port equipped with Teflon-coated septum for butane injections. Nine butane injection holes were placed at 1 cm intervals along the tubing inside the vessel. Four vessels were filled with approximately 800 cm³ of Paver Construction Sand (non-sterile) and two vessels contained sterilized Caribbean beach sand (see FIG. 23).

Each vessel contained one sunflower (Sun Gold-Golden Yellow Double) seed placed at a depth of 5.0 cm below soil surface. Each vessel was then watered with 100 ml spring water and positioned on its own drainage tray on a shelf approximately 60 cm below two 33 watt grow light tubes (no sunlight) equipped with a timer set for 16 hours light on, 6 hours light off.

Ambient temperature was recorded, water was sprinkled evenly over the soil surface of each vessel, and n-butane was injected into the root zone (rhizosphere) through the syringe port of the butane enhanced growth vessel according to the regimen shown in Table 8.

TABLE 8
Butane Injection Schedule

| | | | | Ambient |
|---|---|---|---|---|
| Day No. | Time | Volume of Butane | Water Added | Temperature |
| 1 | 16:00 | 240 ml | 200 ml | 21.0° C. |
| 2 | 16:00 | 180 ml | 100 ml | 20.0° C. |
| 6 | 13:00 | 240 ml | 30 ml | 20.0° C. |
| 7 | 15:30 | 200 ml | none | 20.0° C. |
| 8 | 14:00 | 200 ml | 30 ml | 20.0° C. |
| 9 | 16:30 | 200 ml | 10 ml | 20.0° C. |
| 10 | 13:30 | 200 ml | None | 20.0° C. |
| 11 | 06:00 | 200 ml | 25 ml | 20.0° C. |
| 13 | 19:00 | 200 ml | 10 ml | 20.0° C. |
| 14 | 14:00 | 200 ml | 25 ml | 20.0° C. |
| 15 | 15:00 | 200 ml | none | 22.0° C. |
| 16 | 15:30 | 200 ml | None | 22.0° C. |
| 17 | 13:00 | 200 ml | none | 22.0° C. |
| 20 | 14:00 | 200 ml | 20 ml | 22.0° C. |
| 21 | 15:00 | 200 ml | none | 22.0° C. |
| 22 | 13:30 | 200 ml | none | 22.0° C. |

| | |
|---|---|
| 23 | Experiment Ended. |

Final seed growth was observed after 23 days. Final growth measurements for all seeds are recorded in Table 9.

TABLE 9
Seedling Height

| | Butane | Butane Enhanced | Control | Control |
|---|---|---|---|---|
| Day | Enhanced | Caribbean Beach | Paver | Caribbean |
| No. | Paver Sand | Sand | Sand | Beach Sand |
| 23 | 20 cm, | no seed growth or | 17.0 cm, 5.5 cm | no seed |
| | 6.0 cm | germination | | growth or |
| | | | | germination |

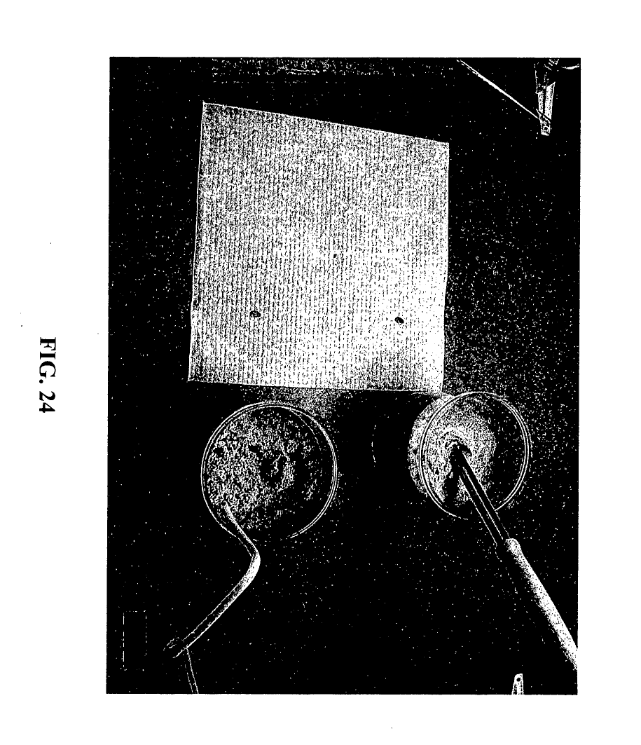

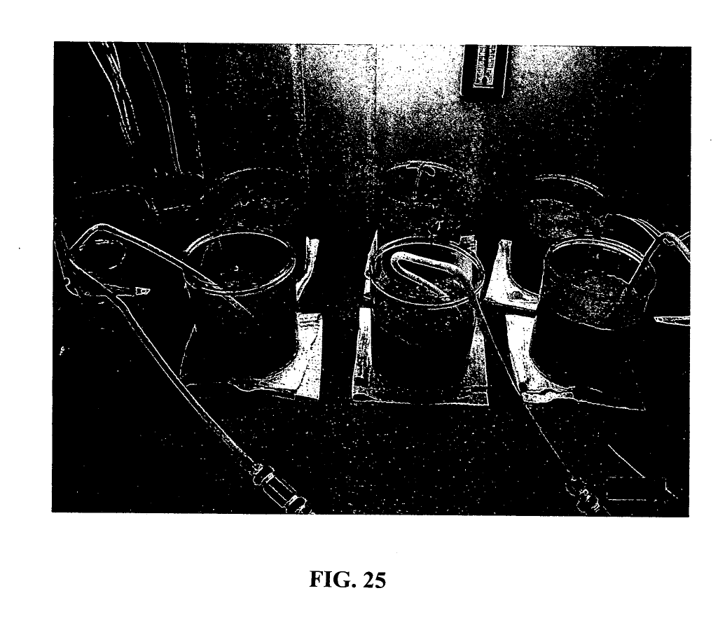

On Day No. 23, all growth vessels were unearthed. All seeds germinated in the Paver Sand. No seed growth or germination was observed in the sterilized beach sand (see FIGS. 24 and 25). This demonstrates the importance of having a healthy and established microbial population present in the soil near the root zone, rhizosphere or germinating seed that will utilize butane as a food source and express the requisite enzymes that enhance plant growth and other plant attributes.

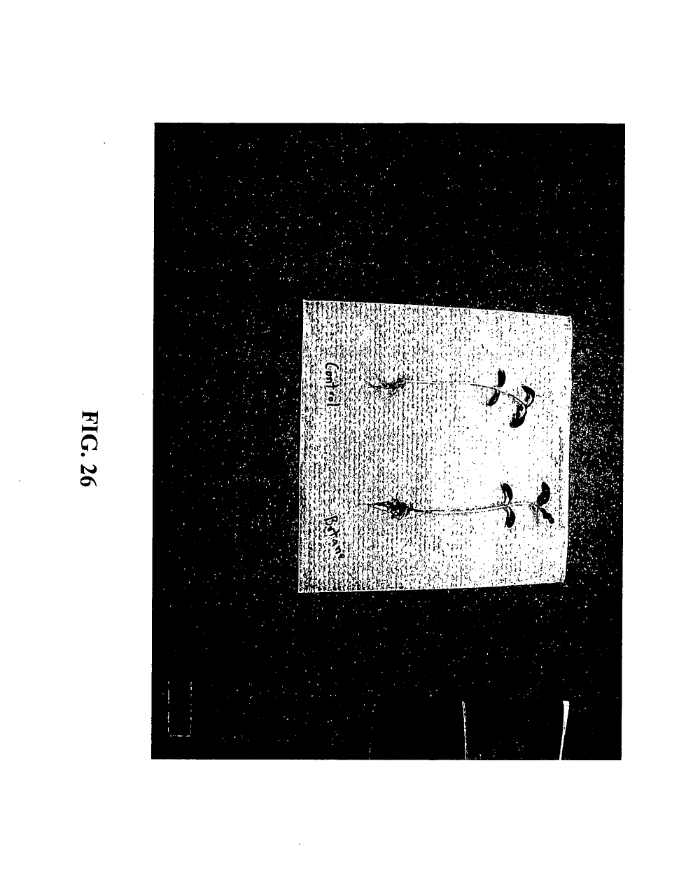

After the plants were unearthed and soil was removed to the extent possible without damaging the roots, the main (longest) roots of one control plant and butane enhanced plant were compared (FIG. 26). The final growth for the control plant was 17.0 cm. The final growth for the butane enhanced plant growth was 20.0 cm. Of particular note was the root development in the butane enhanced plant. The root development was thicker and more robust.

### EXAMPLE 6

### Method of Butane Enhanced Corn Growth in Sand Using Butanated Water

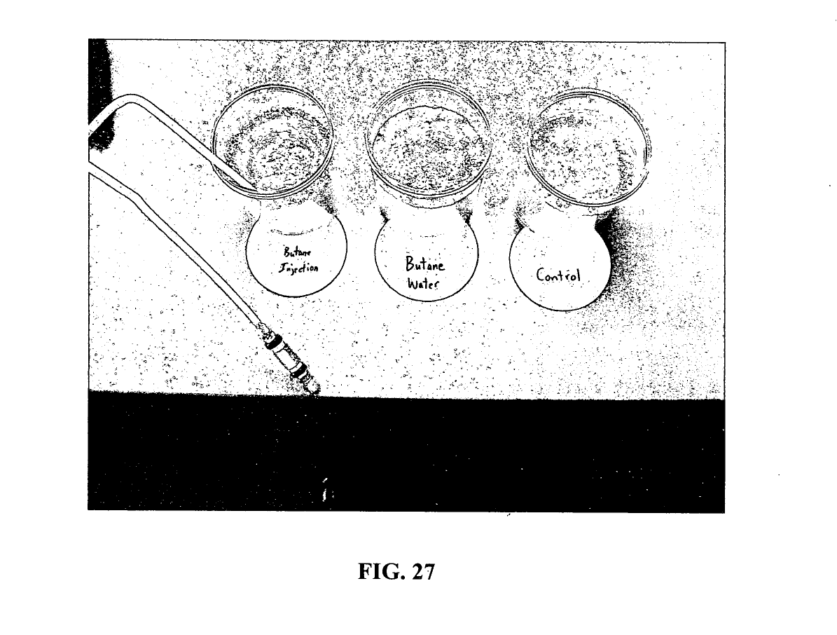

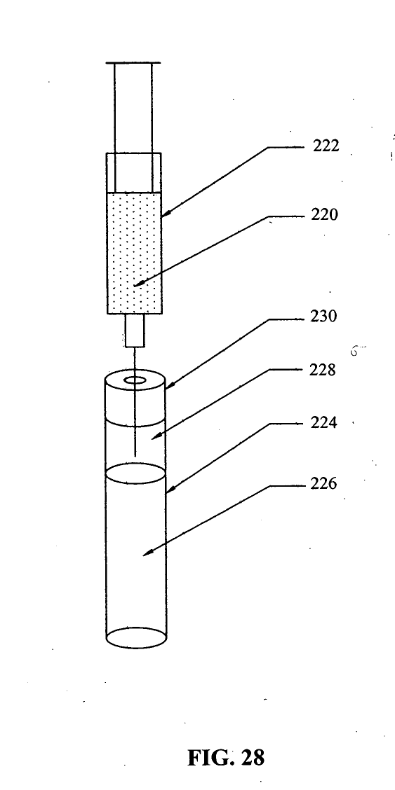

An experiment was conducted to compare corn seed growth in Paver Sand using butane gas injection and butanated water. Paver sand was used to determine if butane enrichment could support corn seed development in a nutrient poor sand (typical arid or desert environment). As shown in FIG. 27, three Nalgene plastic vessels (one for butane gas injection, one for butanated water addition and one for a control), each approximately 11 cm. in diameter and 12 cm. deep, were prepared with three 0.4 cm drainage holes drilled in each base. The butane gas injection vessel was prepared with a 12 cm section of Teflon tubing (see FIG. 20) and connected at one end to a syringe port quipped with Teflon-coated septum for butane injections (Butane Injection vessel). Nine butane injection holes were placed at 1.0 cm intervals along the tubing inside the vessel. FIG. 28 shows the devices that were used for butanated water addition. Butane gas 220 was injected under pressure using a syringe 222 into a 40 -ml VOA vial 224 containing 30 ml of distilled water 226, headspace 228, and a cap 230. After butane gas injection into the VOA vial 224 and rigorous shaking, the contents were poured on the sand surface in the appropriate vessel (Butane Water vessel). All three vessels were filled with approximately 800 cm³ of non-sterile Paver Construction Sand Soil.

Each vessel (Butane Injection, Butane Water and Control) contained two corn seeds. A Peaches and Cream Sweet Corn seed and Honey and Cream Sweet Corn seed were placed at the 12:00 and 6:00 positions in each vessel, respectively. The seeds were inserted approximately 5.0 cm below the sand surface. Each vessel was then watered with 100 ml spring water and positioned on its own drainage tray on a shelf approximately 60 cm below two 33 watt grow light tubes (no sunlight) equipped with a timer set for 16 hours light on, 6 hours light off.

Ambient temperature was recorded and water was sprinkled evenly over the soil surface of the Butane Injection vessel and the Control vessel. Butane was injected into the root zone (rhizosphere) through the syringe port of the Butane Injection vessel according to the schedule shown in Table 10. Butanated water was poured onto the sand surface of the Butane Water vessel. The Control vessel received only light and water.

TABLE 10
Butane Injection Schedule

| | Volume Injected Butane | Volume Butanated | Water Added | |
|---|---|---|---|---|
| | Gas | Water | (Only Butane Injection | Ambient |
| Day No. | (Butane Injection Vessel) | (Butane Water Vessel) | and Control Vessels) | Temperature |
| 1 | 50 ml | 50 ml | 30 ml | 21° C. |
| 2 | 50 ml | 50 ml | 30 ml | 21° C. |
| 3 | 50 ml | 50 ml | 30 ml | 21° C. |
| 4 | 50 ml | 50 ml | 30 ml | 21° C. |
| 5 | 50 ml | 50 ml | 30 ml | 21° C. |
| 6 | 50 ml | 50 ml | 30 ml | 24° C. |
| 7 | 50 ml | 50 ml | 30 ml | 24° C. |
| 8 | 50 ml | 50 ml | 30 ml | 22° C. |
| 9 | — | — | — | — |
| 10 | 50 ml | 50 ml | 30 ml | 21° C. |
| 11 | 50 ml | 50 ml | 30 ml | 21° C. |
| 12 | 50 ml | 50 ml | 30 ml | 21° C. |
| 13 | 50 ml | 50 ml | 30 ml | 21° C. |
| 14 | 50 ml | 50 ml | 30 ml | 21° C. |
| 15 | 50 ml | 50 ml | 30 ml | 21° C. |
| 16 | 50 ml | 50 ml | 30 ml | 21° C. |
| 17 | 50 ml | 50 ml | 30 ml | 21° C. |
| 18 | 50 ml | 50 ml | 30 ml | 21° C. |
| 19 | 50 ml | 50 ml | 30 ml | 25° C. |
| 20 | 50 ml | 50 ml | 30 ml | 25° C. |
| 21 | 50 ml | 50 ml | 30 ml | 25° C. |
| 22 | 50 ml | 50 ml | 30 ml | 25° C. |
| 23 | 50 ml | 50 ml | 30 ml | 25° C. |
| 24 | 50 ml | 50 ml | 30 ml | 25° C. |
| 25 | 50 ml | 50 ml | 30 ml | 25° C. |

| | |
|---|---|
| 28 | Experiment terminated. |

— not recorded

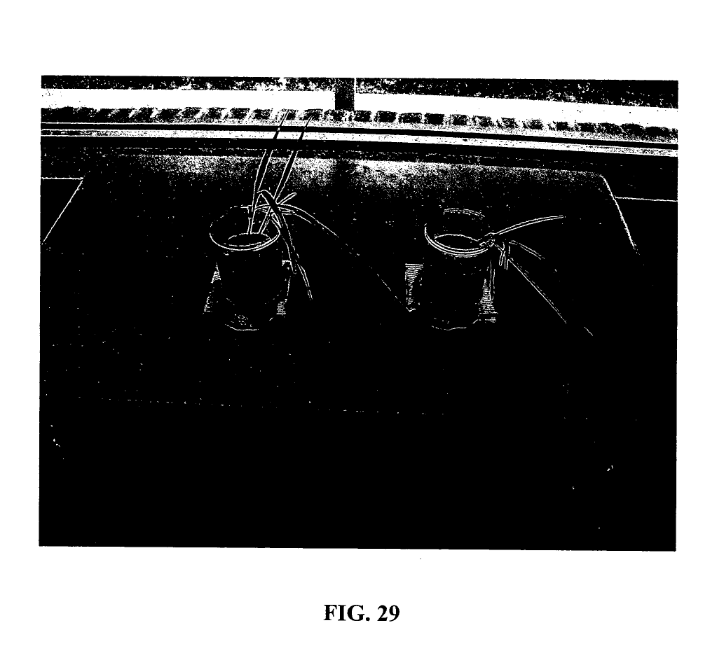

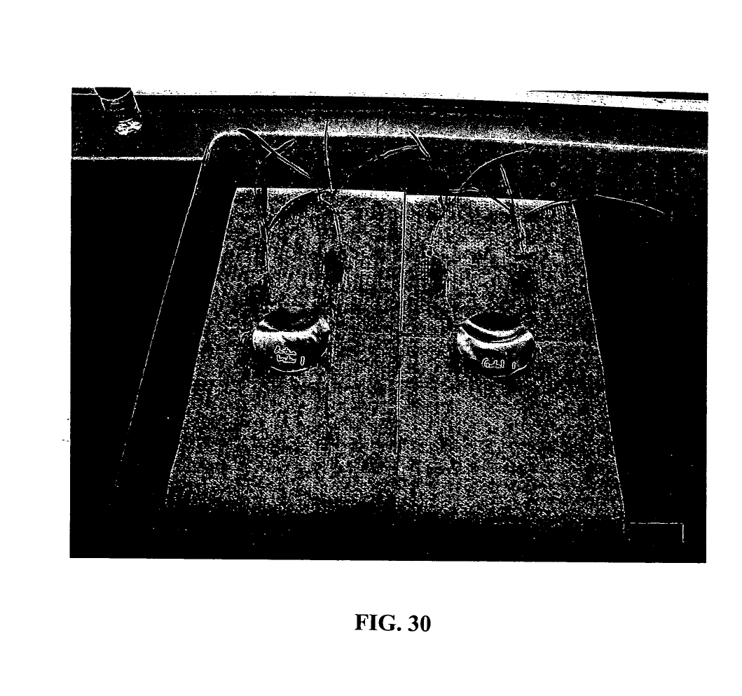

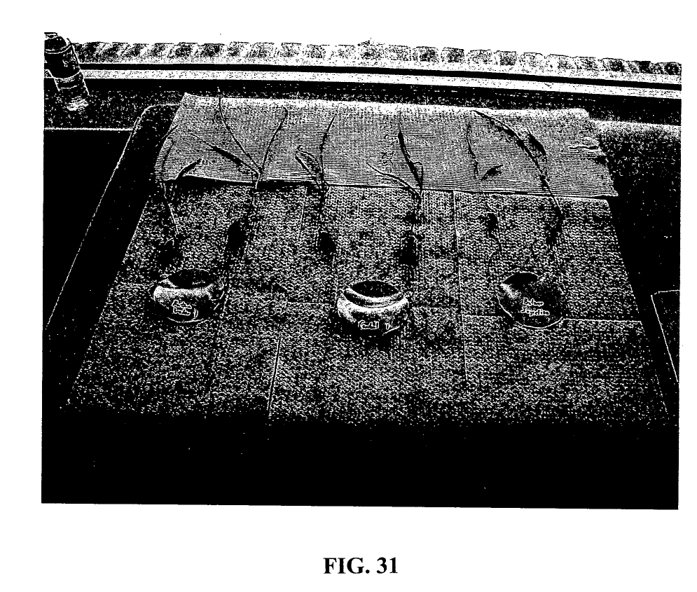

Final seed growth was observed after 28 days. On the final day, a photo was taken showing the Butane Water seed growth as compared with the Control seed growth (FIG. 29). FIG. 30 shows the same comparison with the plants unearthed. FIG. 31 compares the growth of all three experimental vessels.

The butanated water vessels showed plants with thicker root development and more robust corn plant development as compared with the control plants and the plants that received butane gas through injection.

In conclusion, butane injection enhanced plant, seed and bulb growth. However, butane injection as a liquid could potentially result in damage to crops, germinating seeds or developing plant roots since butane as a liquid flashing to a gas is cold (−0.5° C. boiling point). On the other hand, butane as a gas is difficult to deliver precisely to a root zone without significant losses to the atmosphere. Dissolving butane into water and applying the water to growing plants or seeds is a direct and efficient method to deliver butane into the rhizosphere.

While particular embodiments of this invention have been described above for purposes of illustration, it will be evident to those skilled in the art that numerous variations of the details of the present invention may be made without departing from the invention.

1. An apparatus for enhancing plant growth comprising a source of alkane and an applicator in flow communication with the alkane source for applying the alkane to a plant.

2. The apparatus of claim 1, wherein the alkane comprises butane, propane, methane and/or ethane.

3. The apparatus of claim 1, wherein the alkane comprises butane.

4. The apparatus of claim 1, further comprising means for applying water to the plant.

5. The apparatus of claim 4, wherein the water is applied to the plant together with the alkane.

6. The apparatus of claim 4, wherein the water is stored with the alkane.

7. The apparatus of claim 4, wherein the water is applied to the plant separately from the alkane.

8. The apparatus of claim 4, wherein the water is stored separately from the alkane.

9. The apparatus of claim 1 further comprising means for applying an oxygen-containing gas to the plant.

10. The apparatus of claim 9, wherein the oxygen-containing gas is applied to the plant together with the alkane.

11. The apparatus of claim 9, wherein the oxygen-containing gas is applied to the plant separately from the alkane.

12. The apparatus of claim 9, wherein the oxygen-containing gas is applied to the plant with water.

13. The apparatus of claim 9, wherein the oxygen-containing gas is applied to the plant with water and the alkane.

14. The apparatus of claim 1, further comprising means for applying at least one plant growth-enhancing additive to the plant.

15. The apparatus of claim 14, wherein the plant growth-enhancing additive comprises at least one nutrient.

16. The apparatus of claim 15, wherein the at least one nutrient comprises nitrogen, ammonia, orthophosphate and/or fertilizer.

17. The apparatus of claim 14, wherein the plant growth-enhancing additive comprises at least one insecticide.

18. The apparatus of claim 14, wherein the plant growth-enhancing additive comprises alkane-utilizing bacteria.

19. The apparatus of claim 1, wherein the alkane source comprises a canister.

20. The apparatus of claim 19, further comprising an opening in the canister structured and arranged to receive the applicator.

21. The apparatus of claim 19, wherein the alkane is pressurized within the canister.

22. The apparatus of claim 19, further comprising a pressurization port in the canister.

23. The apparatus of claim 19, wherein the alkane is pressurized by a pressurization gas.

24. The apparatus of claim 23, wherein the pressurization gas comprises air, nitrogen and/or oxygen.

25. The apparatus of claim 19, further comprising a fill port in the canister.

26. The apparatus of claim 19, wherein the canister is refillable.

27. The apparatus of claim 19, wherein the canister is replaceable.

28. The apparatus of claim 1, further comprising a valve for regulating flow between the alkane source and the applicator.

29. The apparatus of claim 1, wherein the applicator is structured and arranged for insertion into soil.

30. The apparatus of claim 1, wherein the applicator comprises an uptake tube having an inlet and an outlet, wherein the inlet of the uptake tube is located within the alkane source.

31. The apparatus of claim 1, wherein the applicator comprises an application tube for applying the alkane source, the application tube having an inlet and an outlet, wherein the inlet of the application tube is in flow communication with the outlet of the uptake tube.

32. The apparatus of claim 1, wherein the applicator comprises a flow tip at a distal end of the applicator for applying the alkane to the plant.

33. The apparatus of claim 28, wherein the flow tip comprises a tapered nozzle.

34. The apparatus of claim 28, wherein the flow tip comprises a spray nozzle.

35. The apparatus of claim 1, wherein the applicator comprises a venturi for entraining at least one material selected from the group comprising air, water and plant growth-enhancing additives in the alkane when the alkane is applied to the plant.

36. The apparatus of claim 31, wherein the venturi comprises at least one air inlet hole.

37. The apparatus of claim 4, further comprising:
a rubber aeration bulb in flow communication with the application tube, wherein the bulb is hand pumped to inject air into the application tube; and
a check valve to regulate flow between the rubber aeration bulb and the application tube.

38. An apparatus for enhancing plant growth, the apparatus comprising:
a plant container; and
an alkane applicator in flow communication with the plant container.

39. The apparatus of claim 38, further comprising a source of the alkane.

40. The apparatus of claim 38, wherein the alkane comprises butane.

41. The apparatus of claim 38, wherein the alkane applicator comprises a perforated tube located in the interior of the container.

42. An apparatus for enhancing plant growth, the apparatus comprising:
an alkane source;
a tank in flow communication with the alkane source; and
a sprayer for applying the alkane source to a plant, wherein the sprayer is in flow communication with the tank.

43. The apparatus of claim 42, wherein the alkane source is selected from the group comprising butane, propane, methane and/or ethane.

44. The apparatus of claim 42, further comprising means for oxygenating the alkane source within the tank.

45. The apparatus of claim 44, further comprising a gas diffuser in the tank.

46. The apparatus of claim 44, further comprising an air vent on the tank.

47. The apparatus of claim 42, wherein a liquid carrier is introduced to the alkane source in the tank.

48. The apparatus of claim 42, wherein water is introduced to the alkane source in the tank.

49. The apparatus of claim 42, wherein the sprayer is structured and arranged to apply the alkane source to soil.

50. A method for enhancing growth of a plant, the method comprising applying an alkane to the plant using an applicator that is in flow communication with a source of the alkane.

51. The method of claim 50, wherein the alkane is applied to the plant by injecting the alkane adjacent to a root zone of the plant.

52. The method of claim 50, wherein the alkane is applied to soil in which the plant is situated.

53. The method of claim 50, wherein the alkane is topically applied to the plant.

54. The method of claim 50, wherein the alkane is applied to the plant intermittently.

55. The method of claim 50, further comprising applying water to the plant.

56. The method of claim 55, wherein the water is applied to the plant together with the alkane.

57. The method of claim 55, wherein the water is applied to the plant separately from the alkane.

58. The method of claim 50, further comprising applying oxygen-containing gas to the plant.

59. The method of claim 58, wherein the oxygen-containing gas is applied to the plant together with the alkane.

60. The method of claim 58, wherein the oxygen-containing gas is applied to the plant separately from the alkane.

61. The method of claim 50, further comprising applying a plant growth-enhancing additive to the plant.

62. The method of claim 61, wherein the plant growth-enhancing additive is applied to the plant together with the alkane.

63. The method of claim 61, wherein the plant growth-enhancing additive is applied to the plant separately from the alkane.
